(19) United States
(12) Patent Application Publication
(10) Pub. No.: US 2016/0212237 A1
(43) Pub. Date: Jul. 21, 2016

(54) MANAGEMENT SERVER, COMMUNICATION SYSTEM AND PATH MANAGEMENT METHOD

(71) Applicant: FUJITSU LIMITED, Kawasaki-shi (JP)

(72) Inventor: Takamichi NISHIJIMA, Kanagawa (JP)

(73) Assignee: FUJITSU LIMITED, Kawasaki-shi (JP)

(21) Appl. No.: 14/960,492

(22) Filed: Dec. 7, 2015

(30) Foreign Application Priority Data
Jan. 16, 2015 (JP) 2015-007281

(51) Int. Cl. H04L 29/08; H04L 12/46; H04L 12/707

(52) U.S. Cl. CPC H04L 67/32; H04L 45/22; H04L 12/4641

(57) ABSTRACT

A management server manages a transfer path within a network, and includes a transmitter and a processor. The transmitter transmits a request to activate a virtual machine included in the transfer path, and a request to activate an application that executes, as a substitute for the virtual machine, a transfer process executed by the virtual machine until the virtual machine is activated. The processor sets a first path including an execution device that executes an application in the transfer path when the application has been activated. The processor performs a control for switching the first path to a second path in which the execution device in the first path is replaced with the virtual machine after the virtual machine has been activated.

### CROSS-REFERENCE TO RELATED APPLICATION

This application is based upon and claims the benefit of priority of the prior Japanese Patent Application No. 2015-007281, filed on Jan. 16, 2015, the entire contents of which are incorporated herein by reference.

### FIELD

The embodiments discussed herein are related to a management method and a management server of a transfer path of data within a network.

### BACKGROUND

Attention has been focused on a technique called NFV (Network Functions Virtualization). With NFV, functions implemented by network appliances such as a router, a gateway, a load balancer and the like are installed by application programs, and are operated as VMs (Virtual Machines) in a server. NFV ISG (Industry Specification Group) of ETSI (European Telecommunications Standards Institute), which is a standardization group of Europe, has been studying, by using NFV, an implementation of communication performed via a firewall and a proxy server. In this case, a data transfer path (a service chain) on which a plurality of functions that operate within virtual machines in a server are selectively used is employed.

FIG. 1 is an explanatory diagram of an example of a service chain. A firewall and a proxy server (Web Proxy) operate within virtual machines in servers 20 as application programs. In the example illustrated in FIG. 1, a virtual machine VM₁ operates in a server 20a, while a virtual machine VM₂ operates in a server 20b. All packets that are transmitted when a user accesses the Internet are sent via the virtual machine VM₁ in which a firewall is operating and the virtual machine VM₂ in which a Web Proxy is operating. Also, other network functions sometimes operate as virtual machines in a server.

Here, it is assumed that terminals and the virtual machines respectively store a transfer destination in a routing table in association with a final destination of a packet. For example, when a terminal 10A transmits a packet to a terminal 10Z in FIG. 1, the packet transmitted from the terminal 10A is transferred to the virtual machine VM₁, and is processed by an application of the firewall that is operating in the virtual machine VM₁. Similarly, the packet addressed to the terminal 10Z is transferred from the virtual machine VM₁ to the virtual machine VM₂, and is processed by an application of the Web Proxy that is operating in the virtual machine VM₂. The virtual machine VM₂ transfers, to the terminal 10Z, the packet addressed to the terminal 10Z. These routing tables are managed by an OS (Operating System) that is operating respectively in the virtual machines.

As a related technique, a system is proposed in which a communication management device processes packets that flow in a network and each client does not reply to a packet other than a packet transmitted from the communication management device when the client is set to power-saving mode. Upon receipt of a request to connect to a connection destination from an arbitrary client, the communication management device transmits, to the connection destination, a request to recover from the power-saving mode, and executes, as a substitute for the connection destination, a process for preparing for communication with a transmission source of the connection request. As related techniques, documents such as Japanese Laid-open Patent Publication No. 2004-126959 and the like are known.

In a system using a service chain, a modification of a communication path that causes a change, an addition or the like of a virtual machine within the service chain is made in accordance with a request from a user or load status. When a virtual machine is changed or added, a management server that manages a communication path executes a process for changing a path after a virtual machine included in a new path has been activated. Here, unless an OS that operates within a virtual machine has been activated, the activation of the virtual machine is not completed. A considerable length of time is needed to activate an OS within a virtual machine. The management server does not generate a service chain until a virtual machine is activated. Therefore, a requested function is not provided until a new path is set after a virtual machine has been activated.

### SUMMARY

According to an aspect of the embodiments, a management server manages a transfer path within a network, and includes a transmitter and a processor. The transmitter transmits a request to activate a virtual machine included in the transfer path, and a request to activate an application that executes, as a substitute for the virtual machine, a transfer process executed by the virtual machine until the virtual machine is activated. The processor sets a first path including an execution device that executes the application in the transfer path after the application has been activated. The processor performs a control for switching the first path to a second path in which the execution device within the first path is replaced with the virtual machine.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of a service chain.

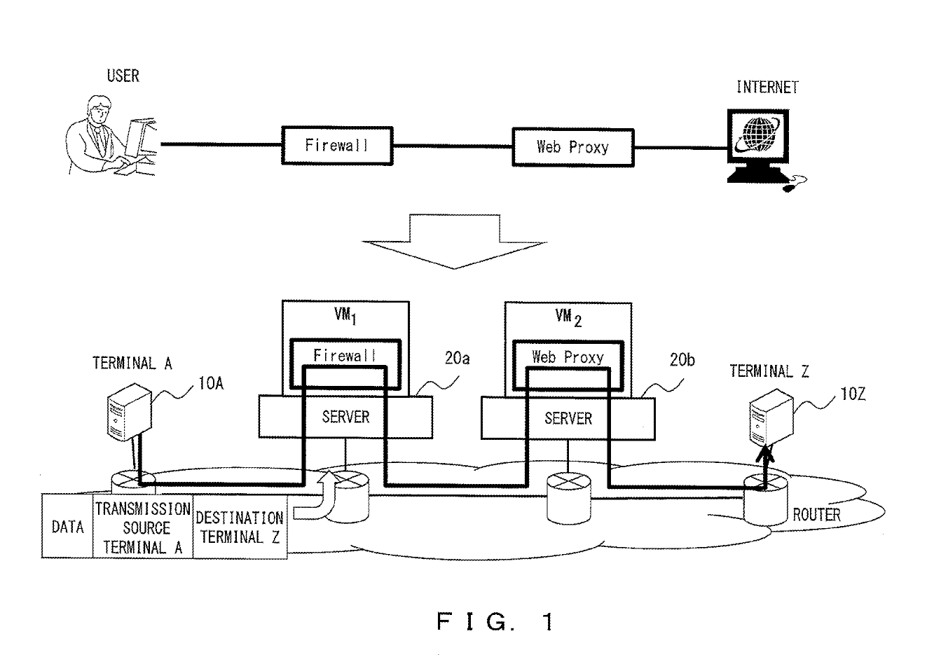

FIG. 2 is an explanatory diagram of an example of operations of virtual machines.

FIG. 3 is an explanatory diagram of an example of virtualization using containers.

FIG. 4 is a flowchart for explaining an example of a method according to an embodiment.

FIG. 5 is an explanatory diagram of an example of a configuration of a management server.

FIG. 6 is an explanatory diagram of an example of a hardware configuration of the management server.

FIG. 7 is an explanatory diagram of an example of a communication path.

FIG. 8 is an explanatory diagram of an example of a process executed in a first embodiment.

FIG. 9 illustrates examples of activation request messages.

FIG. 10 is an explanatory diagram of an example of a process executed in the first embodiment.

FIG. 11 illustrates an example of a rewrite request message.

FIG. 12 illustrates an example of a communication path when a virtual machine has been activated.

FIG. 13 is an explanatory diagram of an example of a process executed in the first embodiment.

FIG. 14A is a flowchart for explaining the example of the process executed in the first embodiment.

FIG. 14B is a flowchart for explaining the example of the process executed in the first embodiment.

FIG. 15 is an explanatory diagram of an example of a process executed in a second embodiment.

FIG. 16 is an explanatory diagram of an example of a process executed in the second embodiment.

FIG. 17 is an explanatory diagram of an example of a communication path to which a third embodiment is applied.

FIG. 18 is an explanatory diagram of an example of a process executed in the third embodiment.

FIG. 19 is a flowchart for explaining an example of a process executed in the third embodiment.

FIG. 20 is an explanatory diagram of an example of a network to which a fourth embodiment is applied.

FIG. 21 is an explanatory diagram of an example of a process executed in the fourth embodiment.

FIG. 22 is an explanatory diagram of an example of a process executed in the fourth embodiment.

FIG. 23 is an explanatory diagram of an example of a process executed in the fourth embodiment.

FIG. 24 illustrates examples of tables used to add a plurality of virtual machines.

FIG. 25 is an explanatory diagram of an example of a network to which a fifth embodiment is applied.

FIG. 26 is an explanatory diagram of an example of a process executed in the fifth embodiment.

FIG. 27 is an explanatory diagram of an example of a process executed in the fifth embodiment.

FIG. 28 is an explanatory diagram of an example of a process executed in the fifth embodiment.

FIG. 29 is an explanatory diagram of an example of a process executed in the fifth embodiment.

FIG. 30 is an explanatory diagram of an example of a process executed in the fifth embodiment.

FIG. 31 is a flowchart for explaining the example of the process executed in the fifth embodiment.

### DESCRIPTION OF EMBODIMENTS

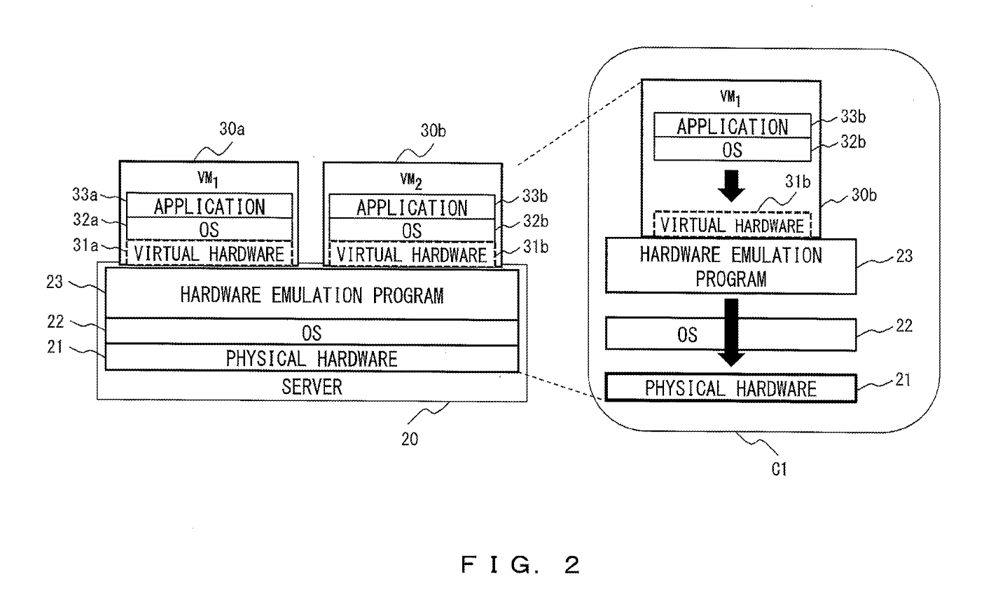

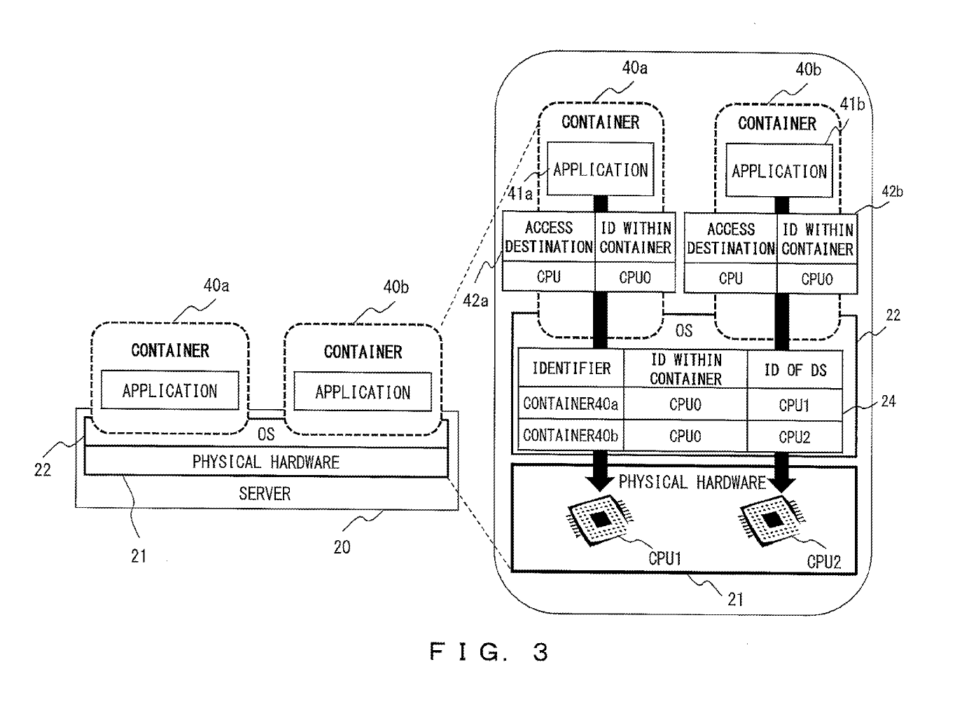

With a method according to an embodiment, when a virtual machine is activated, a container is newly activated. The container executes, as a substitute, a process executed by a virtual machine. The container has been activated before the virtual machine is newly activated. Virtual machines and containers are described with reference to FIGS. 2 and 3.

FIG. 2 is an explanatory diagram of an example of operations of virtual machines 30. The example illustrated in FIG. 2 is a case where a virtual machine 30a and a virtual machine 30b operate in one server 20. However, the number of virtual machines 30 that operate in one server 20 is arbitrary. In the server 20, an OS (Operating System) 22 operates by using physical hardware 21. Also, a program 23 that performs hardware emulation operates on the OS 22. With the program 23 that performs hardware emulation, virtual hardware 31 (31a, 31b) is implemented. An application 33a that operates in the virtual machine 30a operates on an OS 32a by using the virtual hardware 31a. Similarly, an application 33b that operates in the virtual machine 30b operates on an OS 32b that operates by using the virtual hardware 31a. Accordingly, when the OS 32b makes a process request to the virtual hardware 31b in accordance with a process of the application 33b, the process request is made to the program 23 that performs hardware emulation as indicated by a case C1. Because the process request is made from the OS 22 to the physical hardware 21 in accordance with the process of the program 23, the process is executed by the application 33b that operates in the virtual machine 30b. Namely, the OS 32 that operates in the virtual machine 30 has been activated by the time the activation of the virtual machine 30 is completed. Accordingly, when the virtual machine 30 is used, there is an advantage in that an arbitrary OS 32 can be activated in each of the virtual machines 30. However, the activation of the virtual machine 30 is not completed until the OS 32 is activated, leading to a problem in that a considerable length of time is elapsed before activate the virtual machine 30 is activated.

FIG. 3 is an explanatory diagram of an example of virtualization using containers 40. In the server 20, an OS 22 is operating by using the physical hardware 21, and a container 40a and a container 40b are operating on the OS 22. An ID for each container is used in each of the containers, and is converted into an ID for identifying a destination of an access performed by the OS 22. Therefore, an application 41 within each of the containers 40 can execute a process regardless of a configuration of other containers 40 or the physical hardware 21. ID tables 42 (42a, 42b) make an association between an access destination of the application 41 within each of the containers and an ID within the container. Meanwhile, a conversion information table 24 makes an association between an ID used by the OS 22 and each combination of an identifier of a container and an ID within the container.

Assume that CPUs (Central Processing Units) within the server 20 are a CPU1 and a CPU2. Also assume that the application 41a makes a process request to a CPU having an ID, which is an ID used within the container 40a and is CPU0, by using the ID table 42. Then, the designation of CPU0 in the container 40a is converted into CPU1 in accordance with the conversion information table 24. Accordingly, the process for the application 41a is executed by the CPU1. Also, for the container 40b, the designation of CPU0 within the container 40b is read as a designation of CPU 2. Therefore, the process for the application 41b is executed by CPU2.

As described above, in the virtualization using the containers 40, a virtual OS is not used. Accordingly, when a container 40 is activated activation of a virtual OS does not occur. Therefore, the time period for activation of the container 40 is shorter than the length of time period for activation of the virtual machine 30. Here, since the container 40 operates on the OS 22 without using a virtual OS, it can be said that the container 40 is an application operating on the OS 22. It can also be said that a process request to the container 40 is a request for a process to the server 20 in which the container 40 is executed as an application. Note that the number of containers 40 operating in one server 20 is arbitrary.

As described above with reference to FIGS. 2 and 3, the time period for activation of the container 40 is shorter than the length of time period for activation of the virtual machine 30. In the virtualization using containers 40, however, a plurality of containers 40 operate on the same OS 22, and different OSes 22 are not used respectively for the containers. This causes a problem in all of the containers 40 when the problem has occurred at an OS 22 level, leading to a problem in operation management and stability. Accordingly, it is more desirable to use a path employing a virtual machine 30 than to use a path employing a container 40. Therefore, with the method according to the embodiment, a container 40 that executes, as a substitute, the process of a virtual machine 30 is activated when the virtual machine 30 is activated. An activated container executes, as a substitute, a process executed by a virtual machine until the virtual machine is activated. Then, the activated container renders a service equivalent to that rendered when the virtual machine is used.

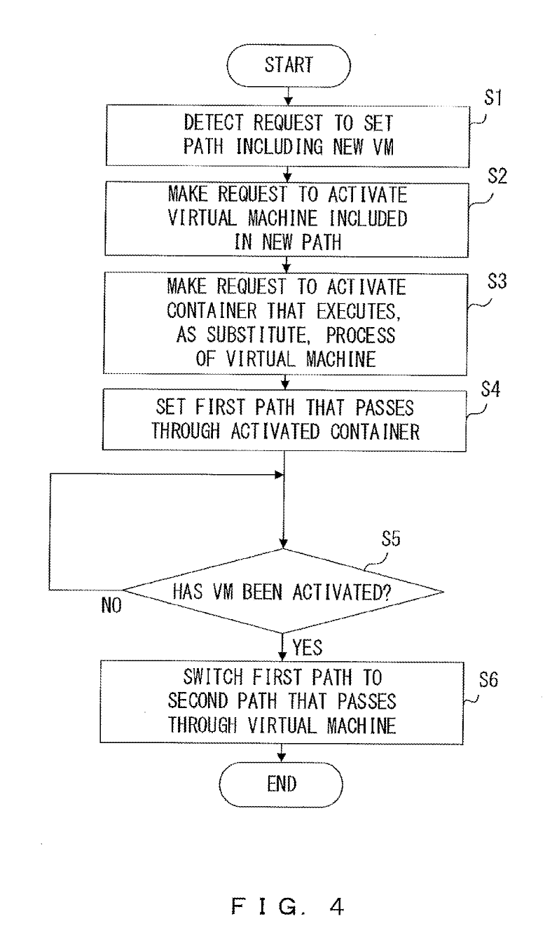

FIG. 4 is a flowchart for explaining an example of the method according to the embodiment. FIG. 4 illustrates an example of a process executed in a system including a server 20, and a management server that manages the server 20 within a network. FIG. 4 illustrates merely one example of operations, which are changeable in accordance with an implementation. For example, the processes of steps S2 and S3 may be executed in parallel, or the order of steps S2 and S3 may be switched.

In step S1, the management server 50 detects a request to set a path including a new virtual machine 30. Here, the management server 50 may receive the request for the path including the new virtual machine 30 from a terminal used by an operator. Moreover, when the management server 50 is provided with an input device for accepting input, the operator may make, to the management server 50, the request to set the path including the new virtual machine 30. In this case, the management server 50 detects the request to set the new path by using input from the input device. The management server 50 decides a server 20 in which the virtual machine 30 set in the new path is operated, and a server 20 in which a container 40 is operated. Here, until the virtual machine 30 to be newly activated is activated, the container 40 executes, as a substitute for the virtual machine 30, a process that is executed by the virtual machine 30 after being activated. Note that the server 20 in which the virtual machine 30 is operated may be the same as or different from the server 20 in which the container 40 that executes, as a substitute, the process of the virtual machine 30 is operated.

In step S2, the management server 50 makes a request to activate the virtual machine 30 included in the new path to the server 20 in which the new virtual machine 30 is operated. The management server 50 also makes a request to activate the container 40 that executes, as a substitute, the process of the virtual machine 30 included in the new path to the server 20 in which the container 40 is operated (step S3).

When the container 40 for which an activation request was made has been activated in step S3, a first path that passes through the activated container 40 is set (step S4). Thereafter, communication using the first path is performed until the virtual machine 30 is activated (“NO” in step S5). When the virtual machine 30 has been activated, a process for switching the first path to a second path that passes through the virtual machine 30 is executed (“YES” in step S5, step S6).

As described above, with the method according to the embodiment, switching is made to a path using a virtual machine 30 after the virtual machine 30 has been activated subsequently to the structuring of a service chain by temporarily using a container 40 that is quickly activated. The path using the virtual machine 30 can be operated with more stability than a path using the container 40, and its operation management is easier. Accordingly, a requested service can be quickly started, and can be stably rendered by using the virtual machine 30.

<Device Configuration>

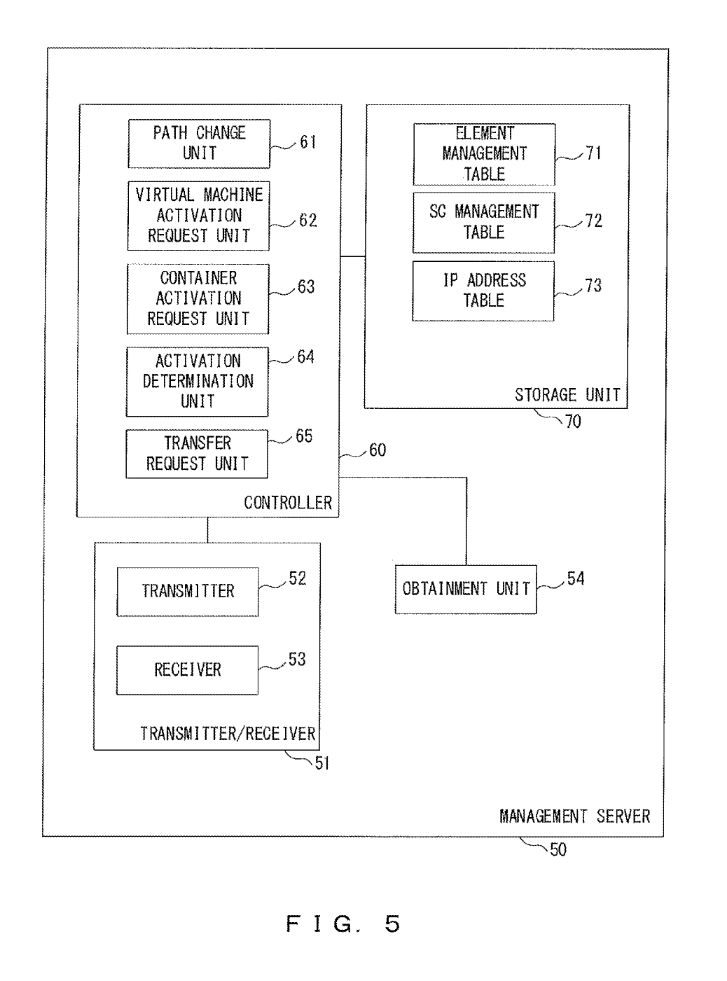

FIG. 5 is an explanatory diagram of an example of a configuration of the management server 50. The management server 50 includes a transmitter/receiver 51, an obtainment unit 54, a controller 60 and a storage unit 70. The transmitter/receiver 51 includes a transmitter 52 and a receiver 53. The controller 60 includes a path change unit 61, a virtual machine activation request unit 62, a container activation request unit 63 and an activation determination unit 64. The controller 60 may also include a transfer request unit 65 as an option. The storage unit 70 stores an element management table 71, an SC management table 72 and an IP address table 73.

The transmitter 52 transmits a control message to a server 20 within a network. The receiver 53 receives a control message from a server 20 within the network. The obtainment unit 54 obtains a request to set a path including a new virtual machine.

The path change unit 61 makes, to the virtual machine activation request unit 62, a request to activate a new virtual machine 30 in response to a request to set a path including the new virtual machine. The path change unit 61 also makes, to the container activation request unit 63, a request to activate a container 40 that executes, as a substitute for a virtual machine 30 to be newly activated, the process of the virtual machine 30. Additionally, the path change unit 61 changes a communication path in a service chain when the virtual machine 30 or the container 40 is activated.

The virtual machine activation request unit 62 selects a server 20 in which a new virtual machine 30 is to be activated, and makes a request to activate the virtual machine 30 to the selected server 20. The container activation request unit 63 selects a server 20 in which a new container 40 is to be activated, and makes a request to activate the container 40 to the selected server 20. The activation determination unit 64 determines whether the virtual machine 30 or the container 40 has been activated, and notifies the path change unit 61 that the virtual machine 30 or the container 40 has been activated. When information (state information) about a process of a transfer packet has been generated with the process of the container 40, the transfer request unit 65 executes a process for transferring the data generated by the container 40 to the virtual machine 30. Examples of the state information include information about an association with an address conversion of proxy, information about a packet passed by firewall, and the like.

The element management table 71 stores information about a terminal 10, a virtual machine 30 and a container 40 that are included in each service chain. The element management table 71 includes, for example, information of an identifier of a device included in a service chain, an identifier of the service chain (SC ID), an IP address, an IP address of a transfer destination of a packet, an IP address of a server 20 in which the transfer destination is operating, and the like.

The SC management table 72 records a transfer path of a packet in a service chain. The SC management table 72 includes an identifier of a device included in a service chain, an identifier of the service chain, the order of the device in the service chain, and the like. In the IP address table 73, IP addresses assignable to a virtual machine 30 and a container 40 to be newly activated are recorded.

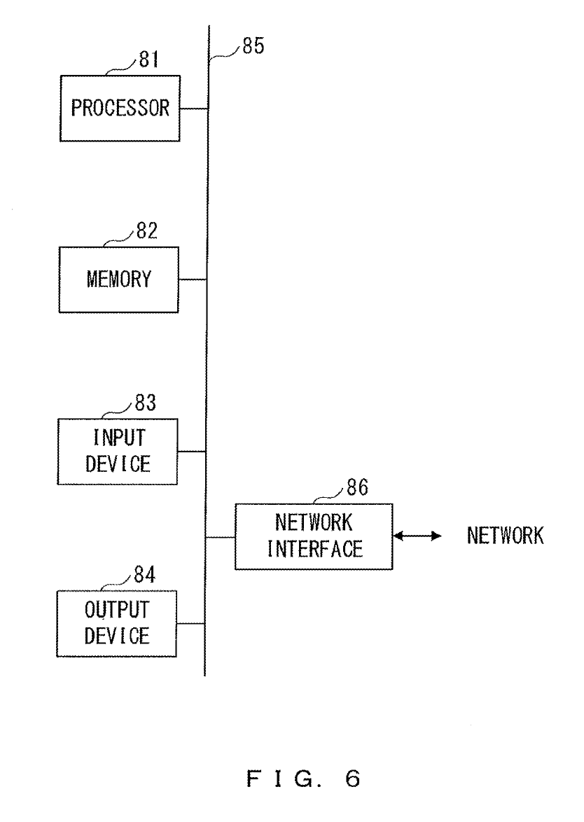

FIG. 6 is an explanatory diagram of an example of a hardware configuration of the management server 50. The management server 50 includes a processor 81, a memory 82, an input device 83, an output device 84, a bus 85 and a network interface 86. The processor 81 is an arbitrary processing circuit including a CPU. The processor 81 uses the memory 82 as a working memory, and executes various processes by executing an OS and application programs. The number of processors 81 is arbitrary, and a plurality of processors 81 may be included. The memory 82 operates as a main storage device or an auxiliary storage device. The memory 82 includes a RAM (Random Access Memory), and also includes a nonvolatile memory such as an EPROM (Erasable Programmable ROM) or the like. The input device 83 is a device, such as a keyboard, a mouse or the like, which an operator can use for a process of input to the management server 50. Data input from the input device 83 is output to the processor 81. The output device 84 is a device that outputs a result of a process executed by the processor. Examples of the output device 84 include an audio output device such as a speaker or the like, and a display.

The processor 81 operates as the controller 60. The memory 82 operates as the storage unit 70. The network interface 86 operates as the transmitter/receiver 51. The obtainment unit 54 is implemented by the network interface 86 or the input device 83.

### First Embodiment

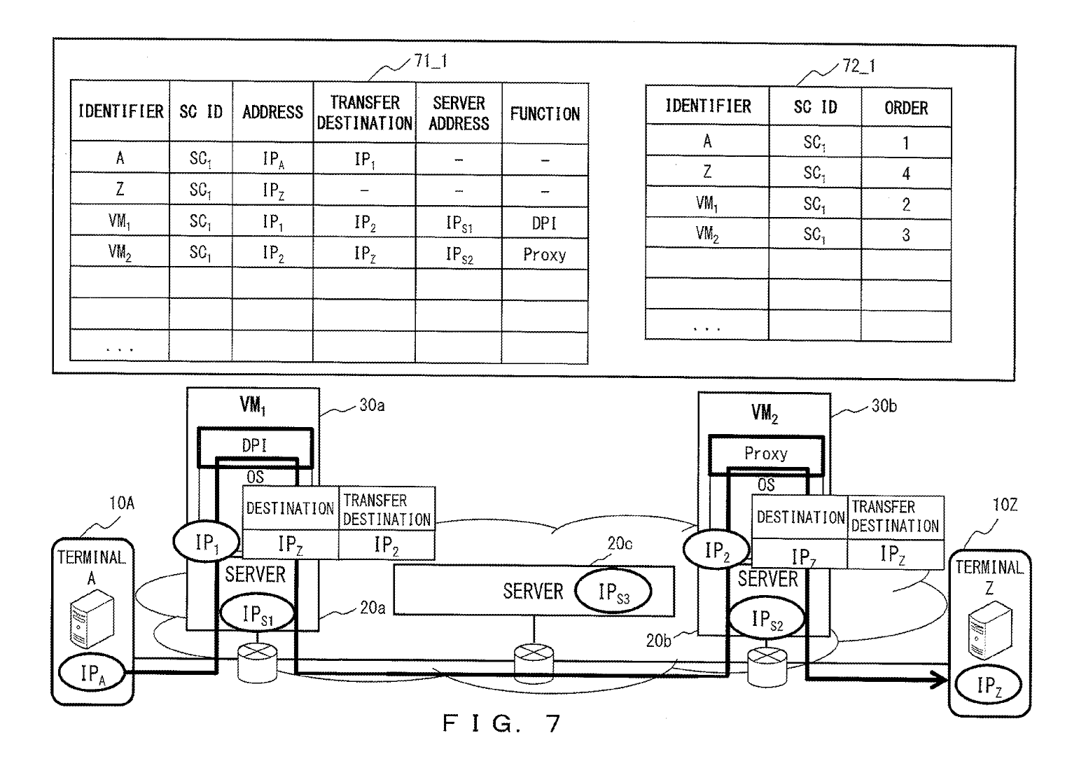

FIG. 7 is an explanatory diagram of an example of a communication path. FIG. 7 illustrates a transfer path used in a service chain having SC ID=SC₁ when the element management table 71_1 and the SC management table 72_2 are stored in the management server 50. In the following description, when contents of the tables vary as time elapses, states of the tables at a corresponding point in time are indicated by appending an underscore and a number to a reference numeral.

In the service chain having SC ID=SC₁ illustrated in FIG. 7, a packet is transmitted from the terminal 10A to the terminal 10Z. A communication path used in the service chain having SC ID=SC₁ includes the terminal 10A, the virtual machine 30a, the virtual machine 30b and the terminal 10Z as indicated by the SC management table 72_1. The packet passes through the terminal 10A, the virtual machine 30a, the virtual machine 30b and the terminal 10Z in this order as indicated by the order of the SC management table 72_1.

The element management table 71_1 includes information of elements used to generate the service chain having SC ID=SC₁. Moreover, the identifier of the virtual machine 30a is VM₁, and the virtual machine 30a operates as a Deep Packet Inspection (hereafter referred to as a “DPI” for short). An identifier of the virtual machine 30b is VM₂, and the virtual machine 30b operates as a Web Proxy (due to space limitations, Web Proxy can be abbreviated as “Proxy” in the figures). In the element management table 71_1, information of the server 20 in which the virtual machine 30 is operating is indicated with an IP address (a server address) assigned to the server 20. Here, the IP address assigned to the terminal 10A is IP_{A}, and the IP address assigned to the terminal 10Z is IP_{Z}. The virtual machine 30a operates in the server 20a, while the virtual machine 30b operates in the server 20b. Moreover, IP addresses respectively assigned to the devices such as the server 20a, the server 20b, the virtual machine 30a and the virtual machine 30b are IP_{S2}, IP_{S2}, IP₁ and IP₂. The server 20c is included in the network. However, a packet that the terminal 10A transmits to the terminal 10Z is not transferred to the server 20c. Accordingly, information of the server 20c is not included in the element management table 71_1 at this point in time. The IP address assigned to the server 20c is assumed to be IP_{S2}.

Additionally, each of the devices stores a transfer destination for using a transfer path set as a service chain. For example, the terminal 10A stores the virtual machine 30a (VM₁) as the transfer destination of the packet addressed to the terminal 10Z (addressed to IP_{Z}). Similarly, the virtual machine 30a (VM₁) stores the virtual machine 30b (VM₂) as the transfer destination of the packet addressed to the terminal 10Z, and the virtual machine 30b stores the terminal 10Z as the transfer destination of the packet addressed to the terminal 10Z.

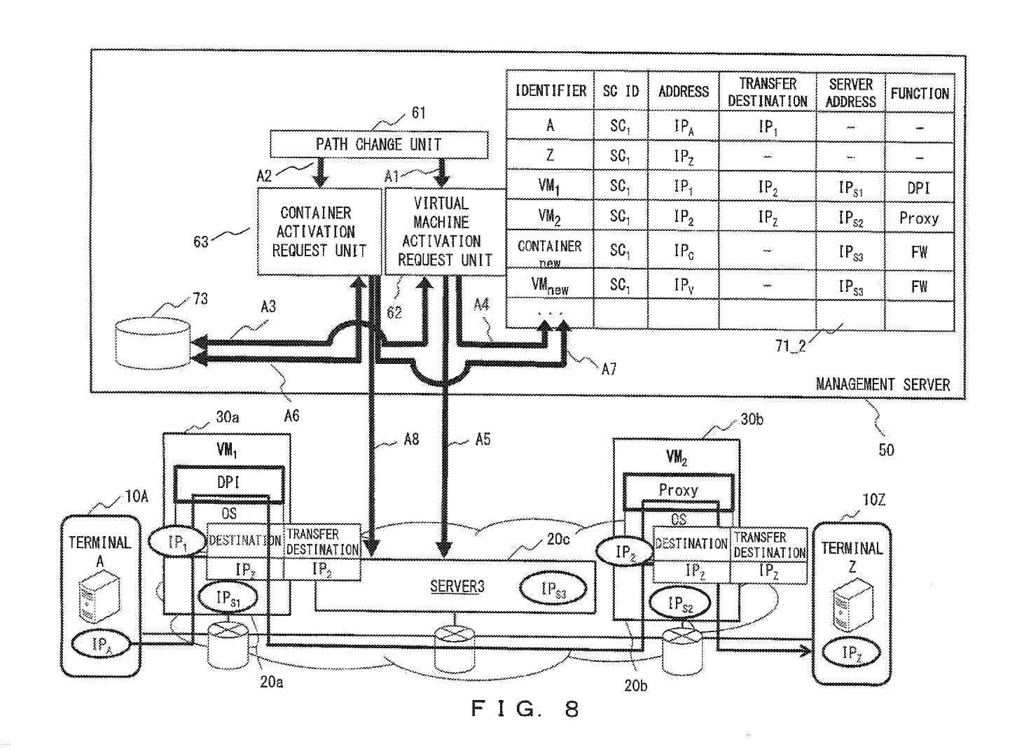

FIG. 8 is an explanatory diagram of an example of a process executed in the first embodiment. An example of the process executed when a virtual machine that operates as a firewall is newly added between the virtual machine 30a that operates as a DPI and the virtual machine 30b that operates as a proxy in the service chain illustrated in FIG. 7 is described below. Due to space limitations, firewall can be abbreviated as “FW” in the figures. In the first embodiment, the management server 50 may not include the transfer request unit 65.

Initially, the path change unit 61 detects that a request to set a path including a new virtual machine in a certain service chain has occurred. The path change unit 61 makes a request to activate the new virtual machine 30 to the virtual machine activation request unit 62 (arrow A1). Assume that the newly added virtual machine 30 is a virtual machine 30c and the identifier of the virtual machine 30c is VM_{new}. The path change unit 61 also makes, to the container activation request unit 63, a request to activate a container 40 that executes, as a substitute for the virtual machine 30c, the process of the virtual machine 30c to be newly activated (arrow A2). Also assume that the identifier of the container 40 to be activated is container_{new}.

The virtual machine activation request unit 62 selects a server 20 in which the virtual machine 30c (VM_{new}) is to be operated, in accordance with a deployment policy of the virtual machine 30. The policy used to select the server 20 is arbitrary. For example, a server 20 having a low processing load is selected. Here, assume that the virtual machine activation request unit 62 has decided to operate the server 20c.

As indicated by an arrow A3, the virtual machine activation request unit 62 selects an IP address assignable to VM_{new} by referencing the IP address table 73. Here, assume that the virtual machine activation request unit 62 assigns IP_{V} as the IP address assigned to VM_{new}. The virtual machine activation request unit 62 deletes the selected IP address from the IP address table 73.

In an arrow A4, the virtual machine activation request unit 62 adds, to the element management table 71, information about the virtual machine 30c to be newly added. The identifier of the virtual machine 30c is VM_{new}, and the IP address assigned to the server 20c in which the virtual machine 30c is to be operated is IP_{S3}. Moreover, the virtual machine 30c is added to the service chain having SC ID=SC₁ as a firewall (FW). Accordingly, the virtual machine activation request unit 62 adds, to the element management table 71_1 (FIG. 7), information of an entry of VM_{new} within the element management table 71_2 with the process indicated by the arrow A4.

In an arrow A5, the virtual machine activation request unit 62 transmits, to the server 20c, a request message for making a request to activate the virtual machine. Details of the request message will be described later.

Meanwhile, the container activation request unit 63 that has received the request indicated by the arrow A2 selects a server 20 in which a container 40 (container_{new}) is to be operated, in accordance with a deployment policy of the container 40. The policy used to select the server 20 in which the container 40 is operated is arbitrary. The server 20 in which the container 40 is operated may be the same as or different from the server 20 in which the new virtual machine 30c is operated. Assume that the container activation request unit 63 has decided to operate the container 40 in the server 20c in the example illustrated in FIG. 8.

As indicated by an arrow A6, the container activation request unit 63 selects an IP address assignable to the container 40 to be newly activated by referencing the IP address table 73. Here, assume that the container activation request unit 63 has selected IP_{C} as the IP address assigned to the container 40. The container activation request unit 63 deletes the selected IP address from the IP address table 73.

In an arrow A7, the container activation request unit 63 adds, to the element management table 71, information about the container 40 to be newly added. The identifier of the container 40 is container_{new}, and the IP address assigned to the server 20c in which the container 40 is operated is IP_{S3}. Moreover, the container 40 is added to the service chain having SC ID=SC₁ as a firewall (FW). Accordingly, the container activation request unit 63 adds information of the entry of container_{new} within the element management table 71_2 by executing the process indicated by the arrow A7. Moreover, the container activation request unit 63 transmits, to the server 20c, a request message for making a request to activate the container 40 (arrow A8)

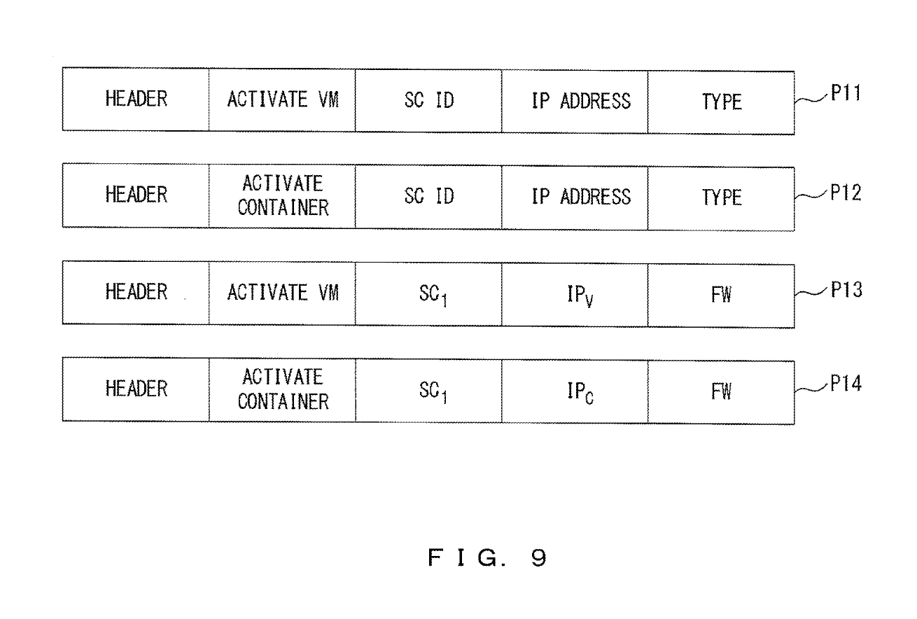

FIG. 9 illustrates examples of activation request messages. P11 is an example of a format of an activation request message used to make a request to activate a virtual machine 30. The activation request message that is used to make a request to activate a virtual machine 30 includes a header, information indicating a request to activate a virtual machine 30 (activate VM), an identifier of a service chain in which the virtual machine 30 is activated, an IP address assigned to the virtual machine 30 to be activated, and type information. The type information indicates a type of a service rendered by the virtual machine 30 to be newly activated. P12 is an example of a format of an activation request message used to make a request to activate a container 40. The activation request message that is used to make a request to activate a container 40 includes a header, information indicating a request to activate the container 40 (container activation), an identifier of a service chain in which the container 40 is to be activated, an IP address assigned to the container 40 and type information. The type information indicates the type of a service rendered by the container 40.

For example, in the arrow A5 illustrated in FIG. 8, an activation request message indicated by P13 is transmitted from the virtual machine activation request unit 62 to the server 20c via the transmitter 52. In contrast, in the arrow A8 illustrated in FIG. 8, an activation request message indicated by P14 is transmitted from the container activation request unit 63 to the server 20c via the transmitter 52.

The server 20c starts to activate the virtual machine 30c upon reception of the activation request message indicated by P13. The server 20c also starts to activate the container 40 upon receipt of the activation request message indicated by P14.

The activation determination unit 64 periodically makes, to the server 20c to which the request to activate the container 40 was made, an inquiry about whether the container 40 has been activated. Examples of the inquiry include a method for examining whether a process is being executed by the container 40 in the server 20c, and a method for transmitting an ICMP (Internet Control Message Protocol) echo to the container 40 in the server 20c to which the request to activate the container 40 has been made.

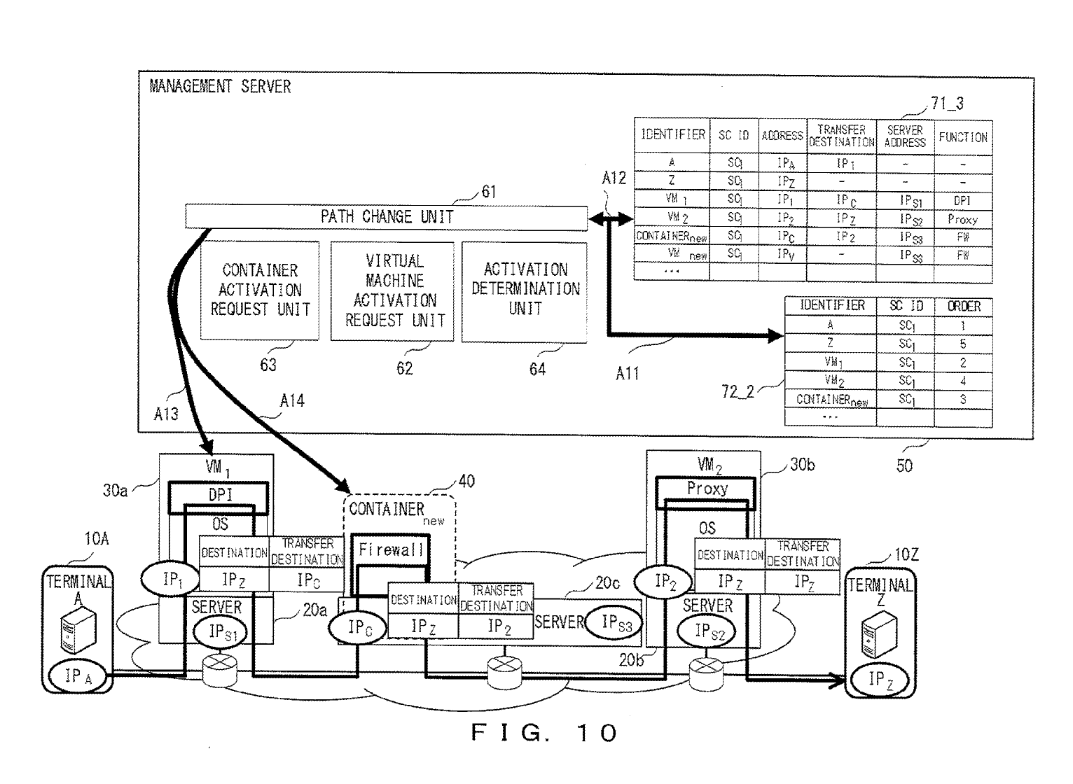

FIG. 10 is an explanatory diagram of an example of a process executed when the container 40 has been activated. The activation determination unit 64 notifies the path change unit 61 that the container 40 has been activated, when the activation determination unit 64 determines that the container 40 has been activated. Moreover, the activation determination unit 64 starts a process for periodically making, to the server 20c to which the request to activate the virtual machine 30c was made, an inquiry about whether the virtual machine 30 has been activated. The process for making an inquiry to the server 20c is similar to that executed in the case where the inquiry about whether the container 40 has been activated is made.

Upon detection of a request to change a path, the path change unit 61 also recognizes that the container 40 is added to the path that extends from the virtual machine 30a (VM₁) to the virtual machine 30b (VM₂). Accordingly, when the container 40 has been activated, the path change unit 61 changes the SC management table 72 so that the order of the container 40 (container_{new}) in the service chain can is before the virtual machine 30a (VM₁) and after the virtual machine 30b (VM₂) (arrow A11). With this process, the SC management table 72_1 (FIG. 2) is changed to an SC management table 72_2 (FIG. 10).

The path change unit 61 decides, by referencing the SC management table 72_2, devices for which a transfer destination of a packet is changed, when the container 40 has been added to the service chain SC₁. The devices for which the transfer destination of the packet addressed to IP_{Z} is changed are the container 40 to be added to the service chain, and the device that transfers the packet to the container 40. Accordingly, the path change unit 61 decides the transfer destinations of the packet addressed to IP_{Z} for the container 40 (container_{new}) and the virtual machine 30a (VM₁). Since the virtual machine 30a (VM₁) transfers the packet to the container 40 (container_{new}), the IP address of the transfer destination in the virtual machine 30a is the address (IP_{C}) of the container 40. Meanwhile, since the container 40 transfers the packet to the virtual machine 30b (VM₂), the IP address of the transfer destination in the container 40 is the address (IP₂) of the virtual machine 30b. Accordingly, the path change unit 61 records the decided transfer destinations in the element management table 71. With this process, the element management table 71_2 (FIG. 8) is changed to an element management table 71_3 (arrow A12).

In an arrow A13, the path change unit 61 makes, to the virtual machine 30a, a request to change, to IP_{C}, the address of the transfer destination of the packet addressed to IP_{Z} by transmitting a rewrite request message to the virtual machine 30a via the transmitter/receiver 51. Moreover, in an arrow A14, the path change unit 61 makes, to the container 40, a request to set, to IP₂, the address of the transfer destination of the packet addressed to IP_{Z} by transmitting a rewrite request message to the container 40.

With the process indicated by the arrows A13 and A14 illustrated in FIG. 10, the transfer path of the packet addressed to the terminal 10Z in the service chain SC₁ includes the terminal 10A, the virtual machine 30a, the container 40, the virtual machine 30b and the terminal 10Z as illustrated in FIG. 10. Moreover, not only the processes of a DPI and a proxy that are respectively executed by the virtual machine 30a and the virtual machine 30b but also the process as a firewall is executed by the container 40.

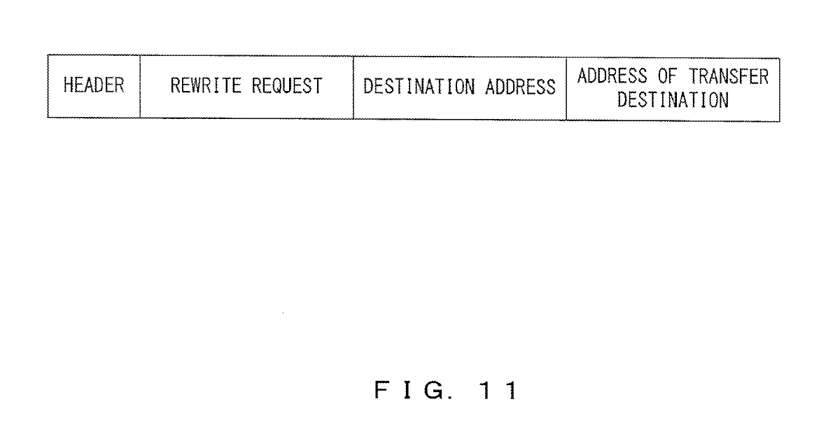

FIG. 11 illustrates an example of a format of the rewrite request message. The rewrite request message includes a header, information indicating the rewrite request message, a destination address of a packet, and an address of a transfer destination of the packet. The device that has received the rewrite request message sets the value of the transfer destination associated with the destination to an address specified by the rewrite request message. Accordingly, as illustrated in FIG. 10, the address of the transfer destination of the packet addressed to the IP_{Z} is changed from IP₂ (the address of the virtual machine 30b) to IP_{C} (the address of the container 40) in the virtual machine 30a. Similarly, the address of the transfer destination of the packet addressed to IP_{Z} is set to IP₂ (the address of the virtual machine 30b) in the container 40.

It is assumed that the virtual machine 30c has been activated thereafter.

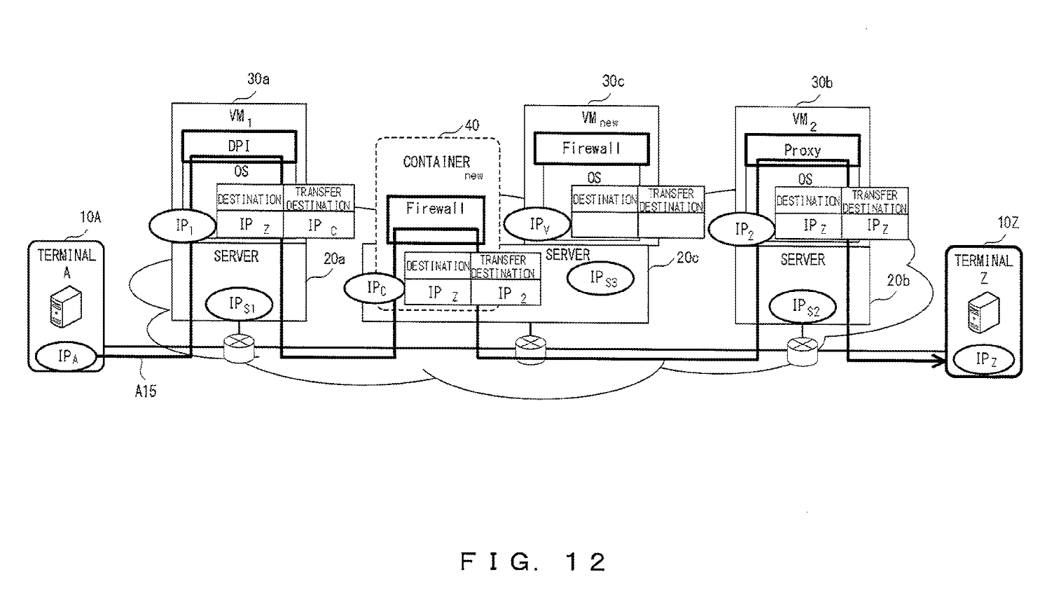

FIG. 12 illustrates an example of a transfer path of the service chain SC₁ when the virtual machine 30c has been activated. At a point in time when the virtual machine 30c has been activated, a path that passes through the virtual machine 30c was not set. Accordingly, a packet addressed to the terminal 10Z is transmitted from the terminal 10A to the terminal 10Z via the virtual machine 30a, the container 40 and the virtual machine 30b as indicated by an arrow A15 illustrated in FIG. 12. When the activation determination unit 64 determines that the virtual machine 30c has been activated, it notifies the path change unit 61 that the virtual machine 30c has been activated.

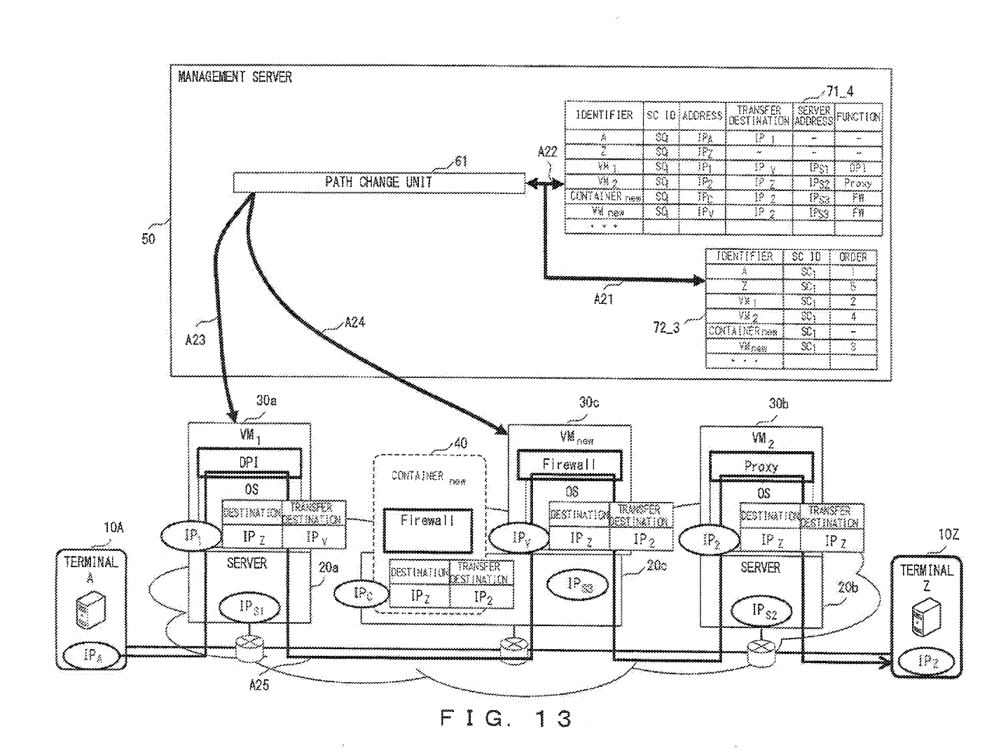

FIG. 13 is an explanatory diagram of an example of a process executed when the virtual machine 30c has been activated. When the virtual machine 30c has been activated, the path change unit 61 starts the process for changing the transfer path of the service chain SC₁ to a path that passes through the virtual machine 30c instead of the container 40.

In an arrow A21, the path change unit 61 adds, to the SC management table 72, information of the virtual machine 30c (VM_{new}), and sets the order of the virtual machine 30c in SC₁ to that between the virtual machine 30a (VM₁) and the virtual machine 30b (VM₂). Accordingly, as indicated by an SC management table 72_3, the order associated with the virtual machine 30c (VM_{new}) is 3. Moreover, the path change unit 61 excludes the container 40 from the transfer path used in the service chain SC₁ by setting the order associated with the container 40 to an invalid value.

By referencing the SC management table 72_3, the path change unit 61 decides devices for which the transfer destination of the packet is changed when the virtual machine 30c is added to the service chain SC₁. In the example illustrated in FIG. 13, the devices for which the transfer destination of the packet is changed are the virtual machine 30c, and the virtual machine 30a that transfers the packet to the virtual machine 30c. Accordingly, the path change unit 61 decides the new transfer destinations of the packet for the virtual machine 30c (VM_{new}) and the virtual machine 30a (VM₁). Since the virtual machine 30a (VM₁) transfers the packet addressed to the IP_{Z} to the virtual machine 30c (VM_{new}), the IP address of the transfer destination of the packet addressed to the IP_{Z} in the virtual machine 30a is the address (IP_{V}) of the virtual machine 30c. Meanwhile, since the virtual machine 30c transfers the packet addressed to the IP_{Z} to the virtual machine 30b (VM₂), the IP address of the transfer destination of the packet addressed to IP_{Z} in the virtual machine 30c is the address (IP₂) of the virtual machine 30b. Accordingly, the path change unit 61 records the decided transfer destinations in the element management table 71. With this process, the element management table 71_3 is changed to an element management table 71_4 (arrow A22).

In an arrow A23, the path change unit 61 makes, to the virtual machine 30a, a request to change, to IP_{V}, the address of the transfer destination of the packet addressed to IP_{Z} by transmitting a rewrite request message to the virtual machine 30a via the transmitter/receiver 51. Moreover, in an arrow A24, the path change unit 61 makes, to the virtual machine 30c, a request to set, to IP₂, the address of the transfer destination of the packet addressed to IP_{Z} by transmitting a rewrite request message to the virtual machine 30c.

With the process indicated by the arrows A23 and A24 illustrated in FIG. 13, the transfer path of the packet addressed to the terminal 10Z in the service chain SC₁ passes through the terminal 10A, the virtual machine 30a, the virtual machine 30c, the virtual machine 30b and the terminal 10Z as indicated by an arrow A25 illustrated in FIG. 13. Namely, the transfer path in the service chain SC₁ is switched from the path illustrated in FIG. 12 to that illustrated in FIG. 13. Moreover, when the path is switched, the virtual machine 30c starts the process as a firewall as a substitute for the container 40.

The example in the case where the server 20 in which the virtual machine 30 or the container 40 is activated is selected in accordance with the deployment policy has been described with reference to FIGS. 7 to 13. However, an operator may specify the server 20 in which the virtual machine 30 or the container 40 is arranged. In this case, the path change unit 61 notifies the virtual machine activation request unit 62 of the server 20 for which the operator makes a designation to arrange the virtual machine 30, and the virtual machine activation request unit 62 makes a request to activate the virtual machine 30 to the notified server 20. Also, for the container 40, the container activation request unit 63 makes a request to activate the container 40 to the server 20 to which the operator makes the request to activate the container 40.

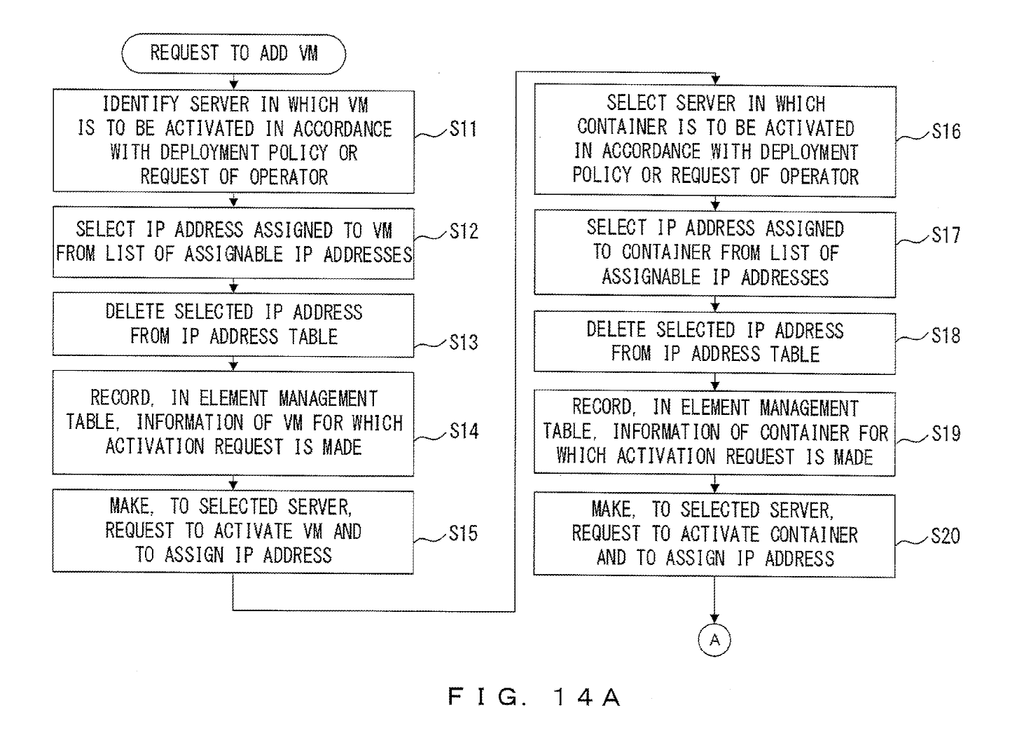

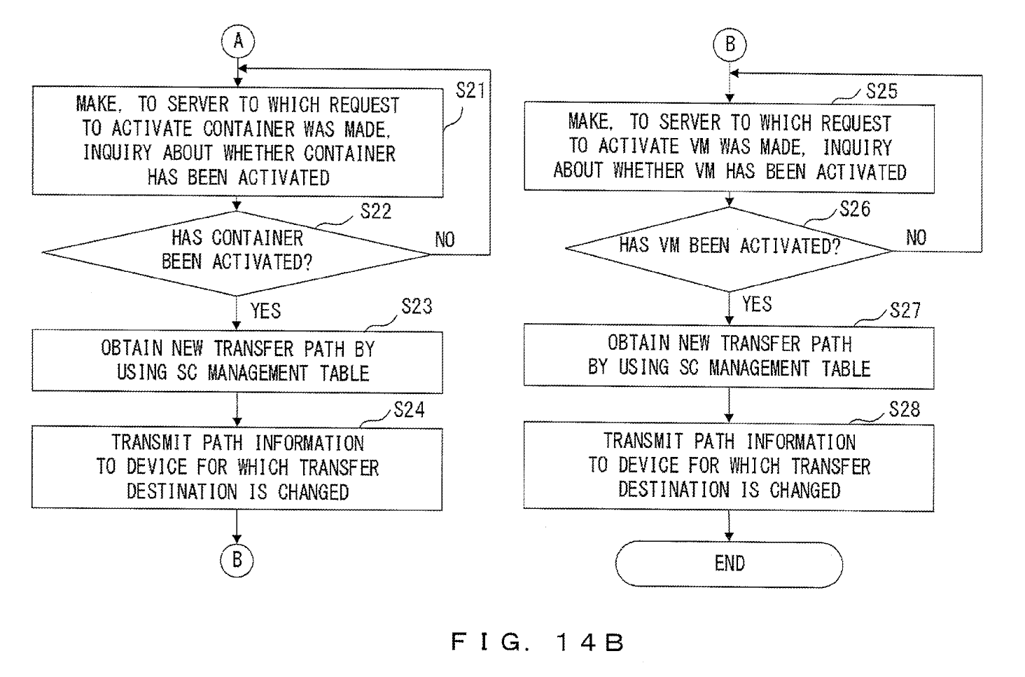

FIGS. 14A and 14B are flowcharts for explaining an example of the process executed in the first embodiment. The virtual machine activation request unit 62 that has received a request to add a virtual machine 30 from the path change unit 61 identifies a server 20 in which the virtual machine 30 is to be activated, in accordance with the deployment policy of the virtual machine 30 or in response to the request from the operator (step S11). The virtual machine activation request unit 62 selects an IP address to be assigned to the virtual machine 30 from a list of assignable IP addresses recorded in the IP address table 73 (step S12). The virtual machine activation request unit 62 deletes the selected IP address from the IP address table 73 (step S13). The virtual machine activation request unit 62 records, in the element management table 71, information of the virtual machine 30 for which an activation request is to be made (step S14). The virtual machine activation request unit 62 makes, to the selected server 20, a request to activate the virtual machine 30 and to assign the selected IP address (step S15).

The container activation request unit 63 that has received the request to add a container 40 from the path change unit 61 identifies the server 20 in which the container 40 is to be activated, in accordance with the deployment policy of the container 40 or in response to the request from the operator (step S16). The container activation request unit 63 selects an IP address assigned to the container 40 from the list of assignable IP addresses recorded in the IP address table 73 (step S17). The container activation request unit 63 deletes the selected IP address from the IP address table 73 (step S18). The container activation request unit 63 records, in the element management table 71, information of the container 40 for which the activation request is made (step S19). The container activation request unit 63 makes, to the selected server 20, a request to activate the container 40 and to assign the selected IP address (step S20).

The activation determination unit 64 makes, to the server 20 to which the request to activate the container 40 was made, an inquiry about whether the container 40 has been activated (step S21). The activation determination unit 64 waits (“NO” in step S22) until the activation of the container 40 is completed. When the activation of the container 40 has been completed, the path change unit 61 obtains a new transfer path by using the SC management table 72 (“YES” in step S22, step S23). The path change unit 61 transmits path information to a device for which the transfer destination is changed within the service chain (step S24). Note that a rewrite request message is used to transmit the path information. With the process of step S24, the container 40 starts, as a substitute, a service scheduled to be rendered by the virtual machine 30 being activated.

The activation determination unit 64 makes, to the server 20 to which the request to activate the virtual machine 30 was made, an inquiry about whether the virtual machine 30 has been activated (step S25). The activation determination unit 64 waits (“NO” in step S26) until the virtual machine 30 is activated. When the virtual machine 30 has been activated, the path change unit 61 obtains a new transfer path by using the SC management table 72 (“YES” in step S26, step S27). The path change unit 61 transmits path information to the device for which the transfer destination is changed in the service chain (step S28).

The process executed when the virtual machine 30c that operates as a firewall is added to the service chain has been described with reference to FIGS. 7 to 13. However, a process executed in an added virtual machine 30 or container 40 is arbitrary.

As described above, by using the method according to the first embodiment, a requested service can be quickly started by temporarily using a quickly activated container 40. Moreover, switching is made to a path using a virtual machine 30 after the virtual machine 30 has been activated, whereby the service can be stably rendered.

### Second Embodiment

A second embodiment refers to a case where information about a process for a transferred packet is generated when the process for transferring the packet is executed in a newly added virtual machine 30 or a container 40 that executes, as a substitute, the process of the virtual machine 30. The management server 50 used in the second embodiment includes the transfer request unit 65 in addition to the path change unit 61, the virtual machine activation request unit 62, the container activation request unit 63 and the activation determination unit 64. Also in the second embodiment, a process of a request to activate a container 40 or a virtual machine 30, and a process for setting a transfer path that passes through a container 40 when the container 40 has been activated are similar to the processes of the first embodiment. For ease of understanding of the invention, examples of the processes executed in the second embodiment are described by taking, as an example, a case where the container 40 and the virtual machine 30c are activated in the server 20c similarly to FIG. 8.

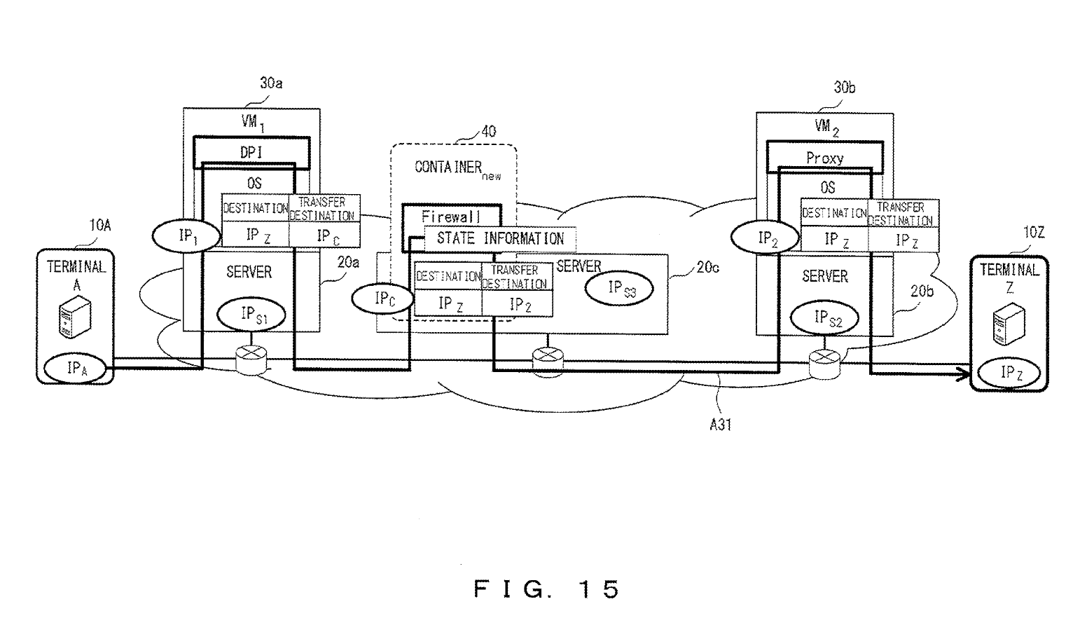

FIG. 15 is an explanatory diagram of an example of a process executed in the second embodiment. FIG. 15 illustrates the example in a state where a transfer path A31 that passes through the container 40 is set. In the second embodiment, the container 40 generates information (state information) about the process of a transfer packet when the container 40 executes, as a substitute, the process of a virtual machine 30c that has not been activated yet. The state information held by the container 40 is information of a packet passed by a firewall, and the like. For example, information of a packet that the container 40 has transferred to the virtual machine 30b among packets that are transferred from the terminal 10A to the container 40 via the virtual machine 30a is recorded as the state information with the process of the firewall.

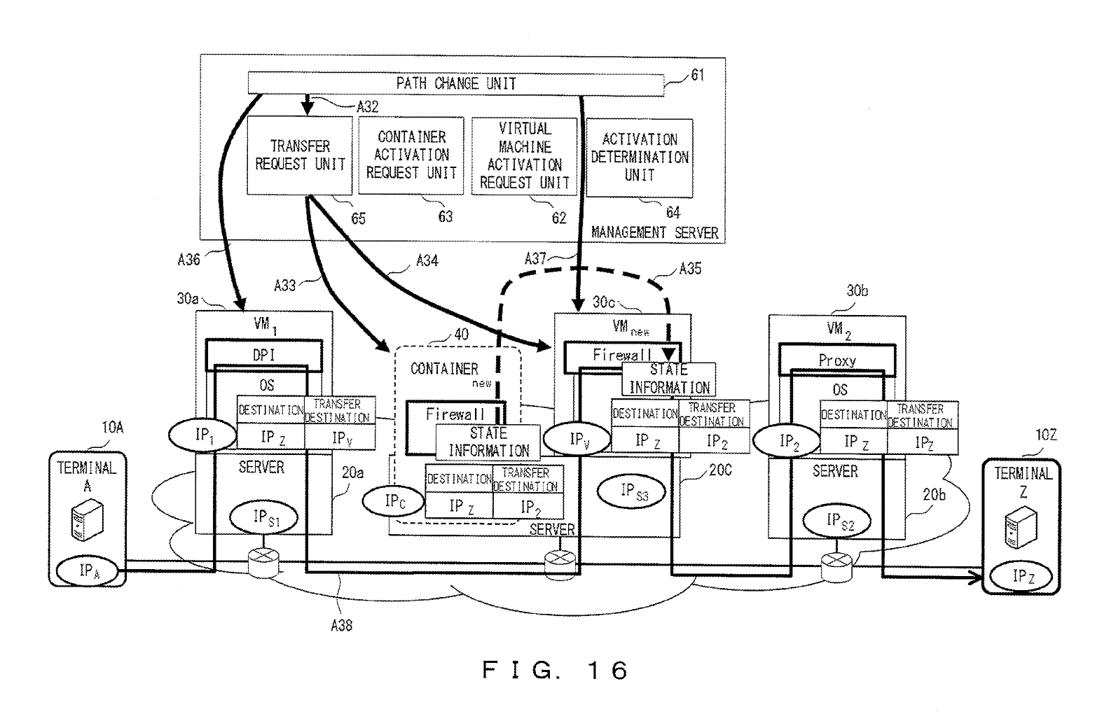

FIG. 16 is an explanatory diagram of an example of a process executed when the activation of the virtual machine 30c has been completed in the second embodiment. Assume that the activation determination unit 64 notifies the path change unit 61 that the virtual machine 30c has been activated. Then, the path change unit 61 determines whether state information has been generated in the container 40 that operates as a substitute for the virtual machine 30c. This determination is performed on the basis of the type of a service rendered by the container 40 or the virtual machine 30c. Here, the container 40 and the virtual machine 30c operate as a firewall that generates state information. Therefore, the path change unit 61 determines that the state information is generated by the container 40. When the path change unit 61 determines that the state information is generated by the container 40, the path change unit 61 makes, to the transfer request unit 65, a request for a process for transferring the state information from the container 40 to the virtual machine 30c prior to a process for switching a path (arrow A32).

The transfer request unit 65 transmits, to the container 40, a request message for making a request to transmit the state information to the virtual machine 30c, in response to the request from the path change unit 61 (arrow A33). The request message includes the address (IP_{V}) of the virtual machine 30c as a notification destination of the state information, and information for specifying the type of the state information to be notified to the virtual machine 30c. Moreover, the transfer request unit 65 transmits a request message for making, to the virtual machine 30c, a request to receive the state information from the container 40, and to use the received state information for the process of the packet (arrow A34). The request message transmitted to the virtual machine 30c includes the address (IP_{C}) of the container 40, which is a transmission source of the state information, and the type of the transferred state information.

Upon receipt of the request message from the transfer request unit 65, the container 40 transmits, to the virtual machine 30c, the state information of the type specified in the request message (arrow A35). Meanwhile, the virtual machine 30c uses the state information received from the transmission source specified in the request message transmitted from the transfer request unit 65 for the subsequent process. In other words, with the transmission process indicated by the arrow A35, the state information generated by the container 40 is transmitted from the container 40 to the virtual machine 30c, and the virtual machine 30c can take over the process executed by the container 40 with the use of the state information.

The path change unit 61 transmits a switching request message to the virtual machine 30a and the virtual machine 30c after the process indicated by the arrow A35 has been executed (arrows A36 and A37). The process indicated by the arrows A36 and A37 is similar to that indicated by the arrows A23 and A24 described with reference to FIG. 13. Accordingly, with the process indicated by the arrows A36 and A37, the transfer path in the service chain SC₁ is switched from the path indicated by the arrow A31 (FIG. 15) to that indicated by the arrow A38.

### Third Embodiment

A third embodiment refers to a process executed when a virtual machine 30 within a service chain is replaced with a different virtual machine 30 in order to recover from a fault in the virtual machine 30 included in the service chain, to reactivate the virtual machine 30, to distribute a load, or the like.

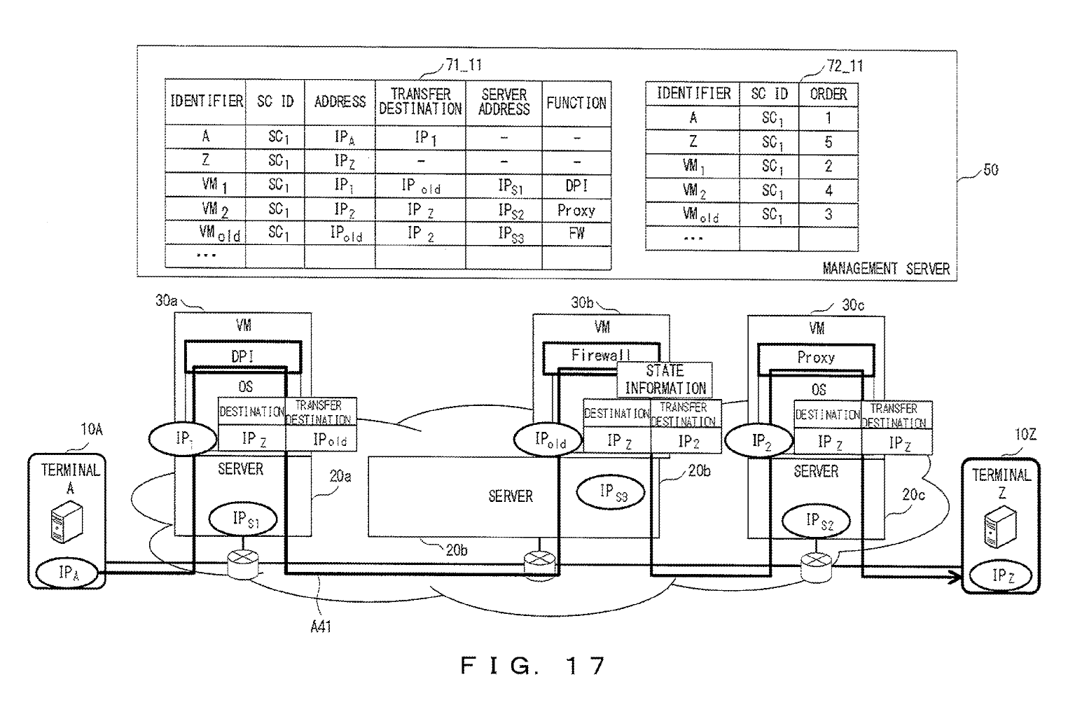

FIG. 17 is an explanatory diagram of an example of a communication path to which the third embodiment is applied. In the example illustrated in FIG. 17, a transfer path used to process the service chain SC₁ is that indicated by an arrow A41. Namely, the packet transmitted from the terminal 10A to the terminal 10Z reaches the terminal 10Z via the virtual machine 30a, the virtual machine 30b and the virtual machine 30c. Moreover, the virtual machine 30a, the virtual machine 30b and the virtual machine 30c operate respectively as a DPI, a firewall and a proxy. The virtual machine 30a, the virtual machine 30b and the virtual machine 30c operate respectively in the server 20a, the server 20b and the server 20c. Accordingly, when the path illustrated in FIG. 17 is used, the management server 50 holds an element management table 71_11 and an SC management table 72_11.

Examples of processes executed in the third embodiment are described by taking, as an example, a case where the virtual machine 30b is replaced with a different virtual machine 30 in a path indicated by an arrow A41.

When the virtual machine 30b is replaced with the different virtual machine 30, the path change unit 61 initially makes, to the virtual machine activation request unit 62, a request to activate a virtual machine 30d (not illustrated), which is a substitute for the virtual machine 30b. The path change unit 61 also makes a request to activate a container 40 that operates until the virtual machine 30d is activated.

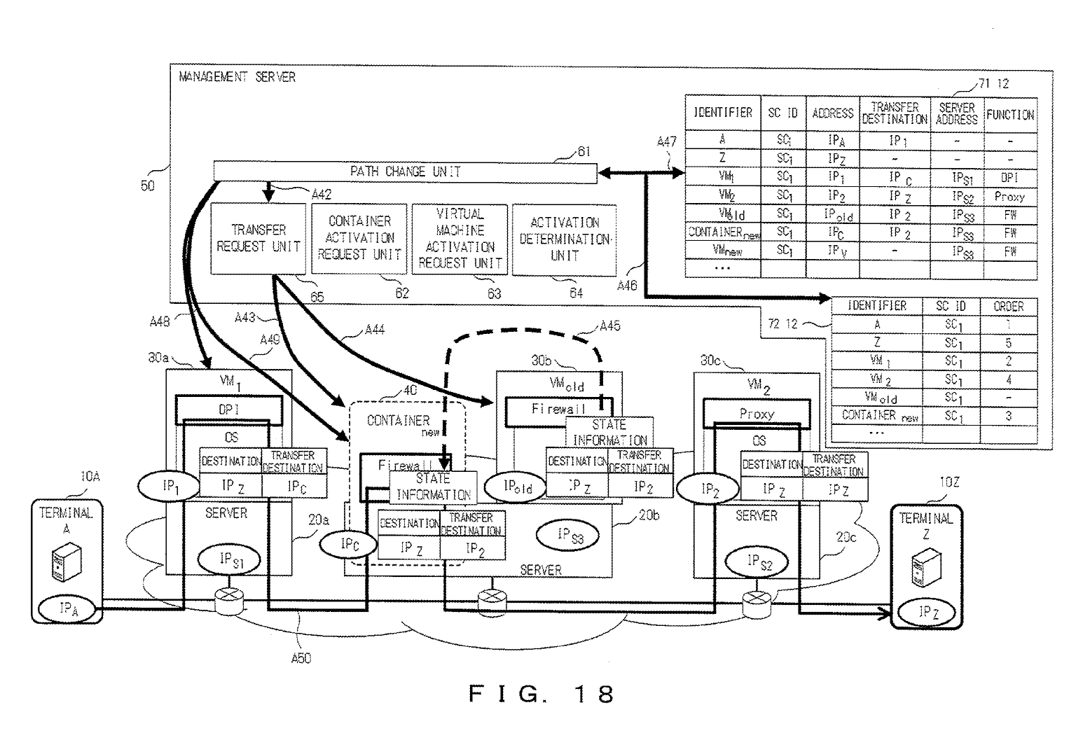

The virtual machine activation request unit 62 selects a server 20 in which the virtual machine 30d is to be activated, in response to the request from the path change unit 61, and makes, to the selected server 20, a request to activate the virtual machine 30d. A process executed by the virtual machine activation request unit 62 when the request to activate the virtual machine 30d is made is similar to the process of the first embodiment. A description of the third embodiment assumes that an identifier of the virtual machine 30d is VM_{new}. With the process of the virtual machine activation request unit 62, an entry of VM_{new} in the element management table 71_12 (FIG. 18) is generated.

By executing a process similar to the process of the first embodiment, the container activation request unit 63 also makes a request to activate a container 40 that operates as a substitute for the virtual machine 30d until the virtual machine 30d is activated. The following example takes a case where the container activation request unit 63 selects the server 20b as an activation destination of the container 40. However, the server 20 in which the container 40 operates may not be a server 20 in which the virtual machine 30 that is deleted from a service chain operates. Assume that the activation determination unit 64 determines that the container 40 has been activated with a process similar to the process of the first embodiment. Also, the description of the third embodiment assumes that an identifier of the container 40 is container_{new}. With the process of the container activation request unit 63, an entry of container_{new} is added to the element management table 71.

FIG. 18 is an explanatory diagram of an example of a process executed in the third embodiment when the container 40 has been activated. When the path change unit 61 is notified from the activation determination unit 64 that the container 40 has been activated, it determines whether state information is generated in the virtual machine 30b to be deleted from the service chain SC₁. Since the virtual machine 30b operates as a firewall in the example illustrated in FIG. 18, the virtual machine 30b generates the state information. Accordingly, the path change unit 61 makes, to the transfer request unit 65, a request for a process for transferring the state information generated in the virtual machine 30b to the container 40 (arrow A42).

The transfer request unit 65 transmits, to the container 40, a request message for making a request to receive the state information from the virtual machine 30b and to use the received state information for the process of the packet, in response to the request made from the path change unit 61 (arrow A43). In the request message transmitted to the container 40, the address of the virtual machine 30b, which is a transmission source of the state information, and the type of the state information are specified. Moreover, the transfer request unit 65 transmits, to the virtual machine 30b, a request message for making a request to transmit, to the container 40, the state information generated at the time of the transfer process of the packet (arrow A44). The request message includes the address (IP_{C}) of the container 40 as the notification destination of the state information, and information for specifying the type of the state information to be notified to the container 40.

Upon receipt of the request message from the transfer request unit 65, the virtual machine 30b transmits, to the container 40, the state information of the type specified in the request message (arrow A45). Meanwhile, the container 40 uses the state information received from the virtual machine 30b for the subsequent process. Namely, in the process indicated by the arrow A45 and subsequent ones, the container 40 takes over the state information generated by the virtual machine 30b. Therefore, the function of the firewall can be continuously provided even if the virtual machine 30b within the service chain CS₁ is replaced with the container 40.

The path change unit 61 recognizes that the container 40 is the container 40 that executes the process until the virtual machine 30d used as a substitute for the virtual machine 30b (VM_{old}) is activated. Accordingly, when the container 40 has been activated, the path change unit 61 sets the order of the container 40 (container_{new}) to a value assigned to the virtual machine 30b (VM_{old}). Meanwhile, by setting the value of the order of the virtual machine 30b (VM_{old}) to an invalid value, the virtual machine 30b is deleted from the service chain SC₁. Accordingly, the SC management table 72_11 (FIG. 17) is changed to the SC management table 72_12.

The path change unit 61 decides transfer destinations of the packet addressed to the terminal 10Z for the container 40 and the virtual machine 30a (VM₁) by referencing the SC management table 72_12 (arrow A46). Since the virtual machine 30a (VM₁) transfers, to the container 40 (container_{new}), the packet addressed to the terminal 10Z (IP_{Z}), the IP address of the transfer destination of the virtual machine 30a is the address (IP_{C}) of the container 40. Meanwhile, since the container 40 transfers, to the virtual machine 30c (VM₂), the packet addressed to the IP_{Z}, the IP address of the transfer destination in the container 40 is the address (IP₂) of the virtual machine 30b. The path change unit 61 records the decided transfer destinations to the element management table 71 (arrow A47). Accordingly, with the process of the path change unit 61, the element management table 71_12 is obtained.

In an arrow A48, the path change unit 61 makes, to the virtual machine 30a, a request to change, to IP_{C}, the address of the transfer destination of the packet addressed to IP_{Z} by transmitting a rewrite request message to the virtual machine 30a via the transmitter/receiver 51. Moreover, in an arrow A49, the path change unit 61 makes, to the container 40, a request to set, to IP₂, the address of the transfer destination of the packet addressed to IP_{Z} by transmitting a rewrite request message to the container 40.

With the process indicated by the arrows A48 and A49, the transfer path of the packet addressed to the terminal 10Z in the service chain SC₁ includes the terminal 10A, the virtual machine 30a, the container 40, the virtual machine 30c and the terminal 10Z. Also the process as a firewall is executed by the container 40.

When the virtual machine 30d has been activated, the transfer path of the service chain SC₁ is switched from the path using the container 40 to that using the virtual machine 30d. A process for transferring state information executed when the path is switched is similar to that described in the second embodiment. The switching process executed after the process for transferring state information is similar to that described with reference to FIGS. 12 and 13 in the first embodiment.

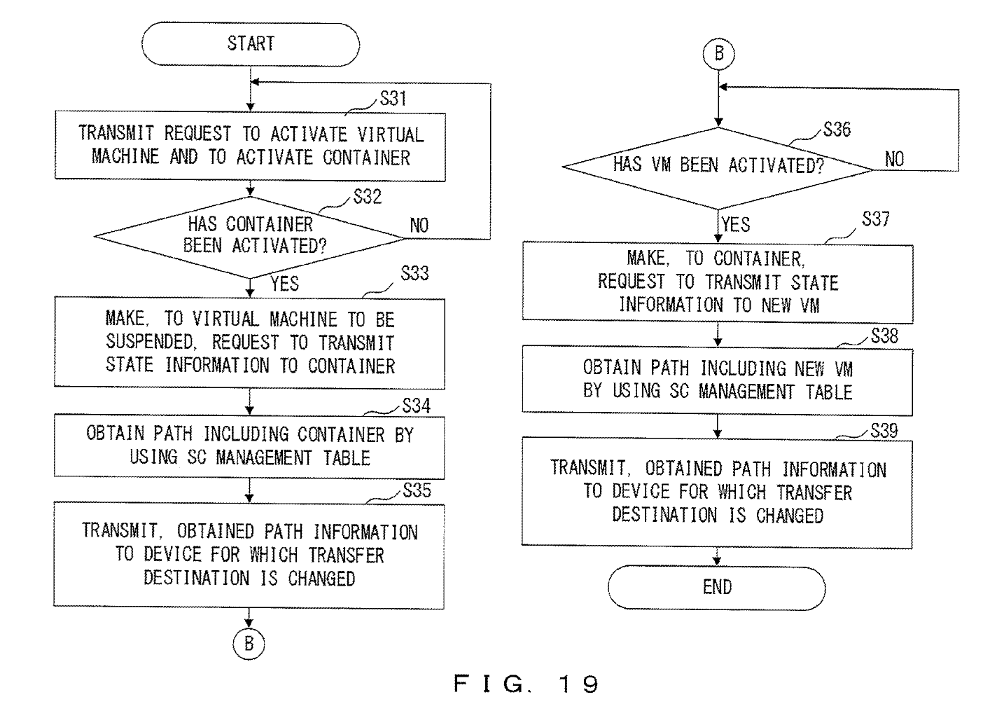

FIG. 19 is a flowchart for explaining an example of a process executed in the third embodiment. Upon detection of a request for a process for switching an operating virtual machine 30 to a new virtual machine 30, the management server 50 transmits a request to activate the new virtual machine 30, and a request to activate the container 40 (step S31). The management server 50 waits (“NO” in step S32) until the container 40 is activated. When the activation of the container 40 has been completed, the transfer request unit 65 within the server 50 makes, to the virtual machine 30 scheduled to be suspended, a request to transfer state information to the container 40 (“YES” in step S32, step S33). The path change unit 61 obtains a path including the container 40 by using the SC management table 72 (step S34). The path change unit 61 transmits the obtained path information to a device for which a transfer destination of a packet is changed (step S35). Thereafter, the management server 50 waits (“NO” in step S36) until the activation of the new virtual machine 30 is completed. When the activation of the new virtual machine 30 has been completed, the transfer request unit 65 makes, to the container 40, a request to transmit the state information to the newly activated virtual machine 30 (step S37). The path change unit 61 obtains a path including the newly activated virtual machine 30 by using the SC management table 72 (step S38). The path change unit 61 transmits the obtained path information to the device for which the transfer destination of the packet is changed (step S39).

As described above, according to the third embodiment, a service can also be rendered by using a container 40 before a newly activated virtual machine 30 starts to be operated when the virtual machine 30 included in a service chain is replaced with a different virtual machine 30 in order to recover from a fault, or the like.

### Fourth Embodiment

A fourth embodiment refers to an example of a process executed when a service chain is generated.

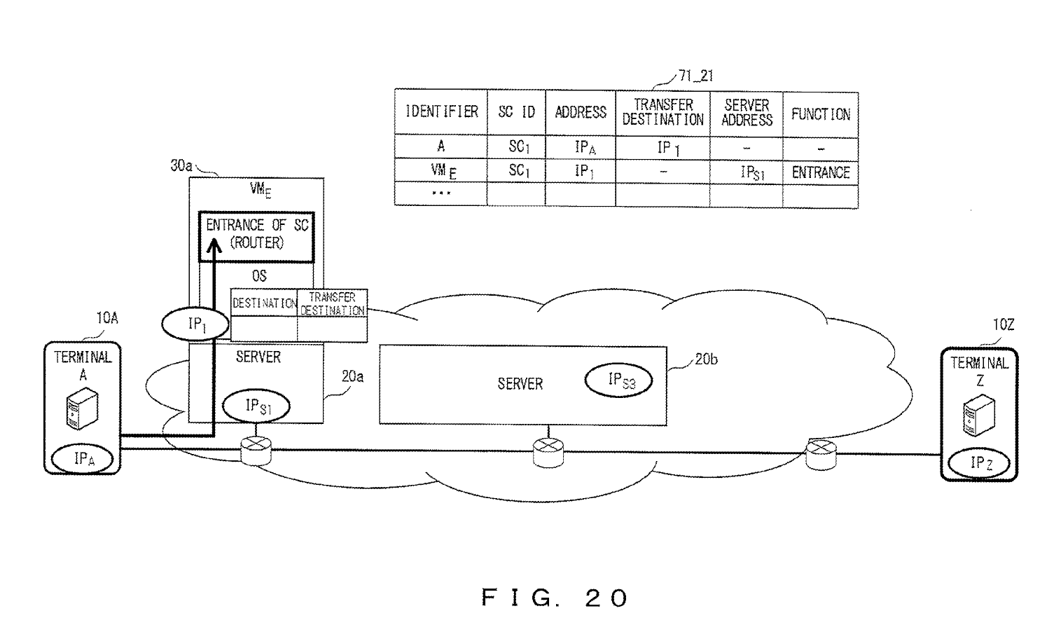

FIG. 20 is an explanatory diagram of an example of a network to which the fourth embodiment is applied. The network includes the terminal 10A, the terminal 10Z, the server 20a and the server 20b. In the server 20a, the virtual machine 30a is operating. The fourth embodiment assumes that the identifier of the virtual machine 30a is VM_{E}. The terminal 10A holds information of the virtual machine 30a in advance as an access destination when the terminal 10A performs communication using the service chain.

Additionally, the management server 50 stores information indicating that the terminal 10A can perform communication by using the service chain via the virtual machine 30a. Accordingly, the management server 50 records, in the element management table 71_21, the terminal 10A (identifier=A) and the virtual machine 30a (VM_{E}) as elements that can be included in the service chain. Note that the virtual machine 30a operates as a default router when it accesses the service chain for the terminal 10A.

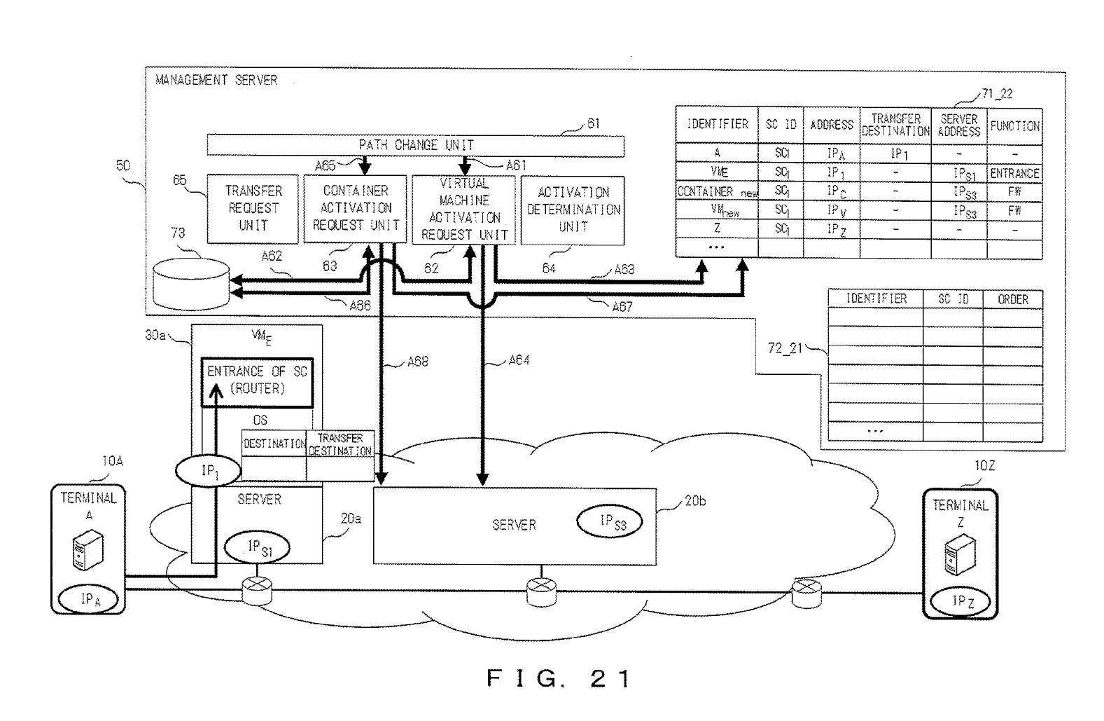

FIG. 21 is an explanatory diagram of an example of a process executed in the fourth embodiment. The example of the process executed when a user of the terminal 10A generates a service chain for communicating with the terminal 10Z via a firewall is described with reference to FIG. 21. The path change unit 61 detects that a request has been made to generate a service chain including a firewall in the path that extends from the terminal 10A to the terminal 10Z. Then, the path change unit 61 adds the terminal 10Z as an element included in the service chain SC₁ associated with the terminal 10A and the virtual machine 30a. Moreover, the path change unit 61 makes, to the virtual machine activation request unit 62, a request for a process for activating the virtual machine 30 that operates as a firewall in the service chain SC₁ (arrow A61). A case where the virtual machine 30b is newly activated is taken as an example below. The identifier of the virtual machine 30b is assumed to be VM_{new}.

Assume that the virtual machine activation request unit 62 decides to operate the virtual machine 30b in the server 20b by using the deployment policy of the virtual machine 30, or the like. The virtual machine activation request unit 62 selects an IP address assigned to VM_{new} by referencing the IP address table 73, and deletes the selected IP address from the IP address table 73 (arrow A62). Here, assume that IP_{V} is assigned to VM_{new}. The virtual machine activation request unit 62 adds, to the element management table 71, an entry of the virtual machine 30b (VM_{new}). Namely, information indicating that the virtual machine 30b operates as a firewall (FW) in the server 20b is recorded in the element management table 71 (arrow A63). Thereafter, the virtual machine activation request unit 62 transmits, to the server 20b, a request message for making a request to activate the virtual machine (arrow A64).

Additionally, the path change unit 61 makes, to the container activation request unit 63, a request for a process for activating the container 40 to be operated until the virtual machine 30 that operates as a firewall in the service chain Sc1 is activated (arrow A65).

Assume that the container activation request unit 63 has decided to operate the container 40 (container_{new}) in the server 20b in accordance with the deployment policy of the container 40. The container activation request unit 63 selects an IP address assigned to the container 40 to be newly activated by referencing the IP address table 73, and deletes the selected IP address from the IP address table 73 (arrow A66). Here, assume that IP_{C} is assigned to the container 40. The container activation request unit 63 adds, to the element management table 71, an entry of the container 40 (container_{new}). Namely, information indicating that the container 40 operates as a firewall (FW) in the server 20b is recorded in the element management table 71 (arrow A67). Accordingly, at a point in time when the process indicated by the arrow A67 has been terminated, the management server 50 includes the element management table 71_22. Meanwhile, the container activation request unit 63 transmits, to the server 20b, a request message for making a request to activate the container 40 (arrow A68).

Even at a stage when the process indicated by the arrow 68 was terminated, the service chain SC₁ that extends from the terminal 10A to the terminal 10Z has not been established. Accordingly, the management server 50 holds the SC management table 72_21 that does not include the information of the service chain SC₁.

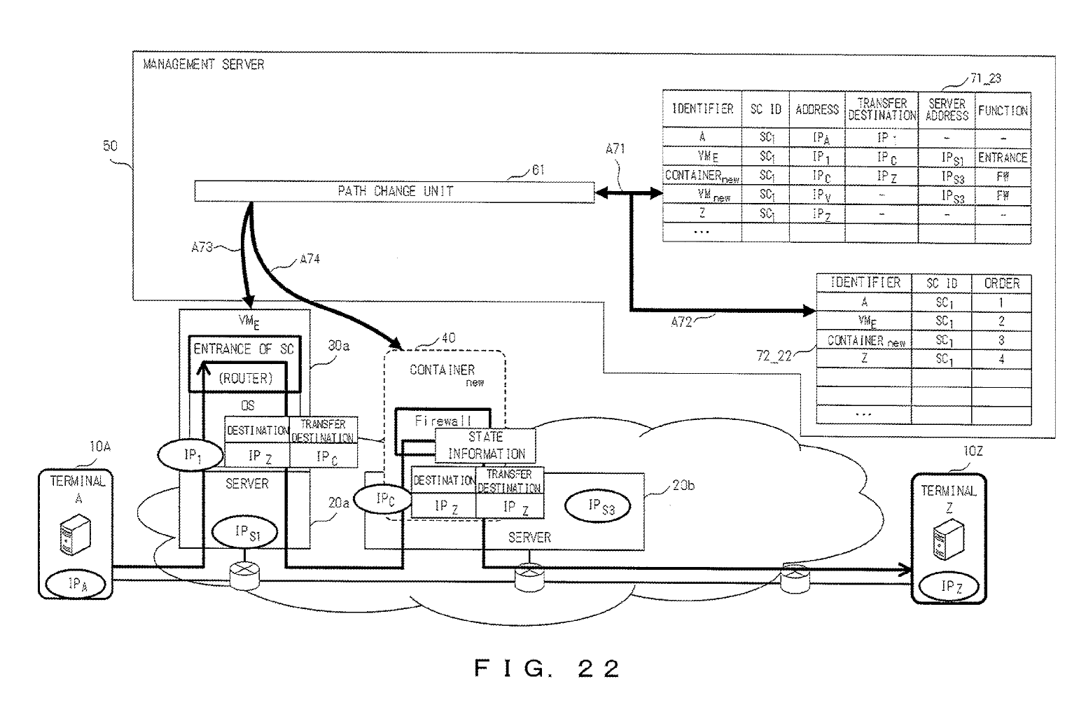

FIG. 22 is an explanatory diagram of an example of a process executed in the fourth embodiment when the container 40 has been activated. By executing a process similar to the process of the first embodiment, the activation determination unit 64 detects that the container 40 has been activated, and notifies the path change unit 61 that the container 40 has been activated. When the path change unit 61 is notified that the container 40 has been activated, the path change unit 61 determines, by using the element management table 71_22 (FIG. 21), that the service chain extending from the terminal 10A to the terminal 10Z via the container 40 can be established. Accordingly, the service chain in which the terminal 10A, the virtual machine 30a (VM_{E}), the container 40 (container_{new}) and the terminal 10Z execute a transfer process in this order is recorded in the SC management table 72 (arrow A72). Accordingly, the SC management table 72_21 (FIG. 21) is changed to an SC management table 72_22.

The path change unit 61 decides transfer destinations of the packet addressed to the terminal 10Z in the devices included in the service chain in the case where the path recorded in the SC management table 72_22 is used, and records the transfer destinations of the packet in the element management table 71. Accordingly, with the process of the path change unit 61, the element management table 71_22 (FIG. 22) is changed to an element management table 71_23. The path change unit 61 determines that the devices for which the transfer destination of the packet is newly set among the devices included in the service chain SC₁ are the virtual machine 30a and the container 40.

In an arrow A73, the path change unit 61 makes, to the virtual machine 30a, a request to set, to IP_{C}, the address of the transfer destination of the packet addressed to IP_{Z} by transmitting a rewrite request message to the virtual machine 30a. In an arrow A74, the path change unit 61 also makes, to the container 40, a request to set, to IP_{Z}, the address of the transfer destination of the packet addressed to IP_{Z} by transmitting a rewrite request message to the container 40.

With the process indicated by the arrows A73 and A74 illustrated in FIG. 22, the transfer path of the packet addressed to the terminal 10Z in the service chain SC₁ includes the terminal 10A, the virtual machine 30a, the container 40 and the terminal 10Z. The container 40 also executes the process as a firewall.

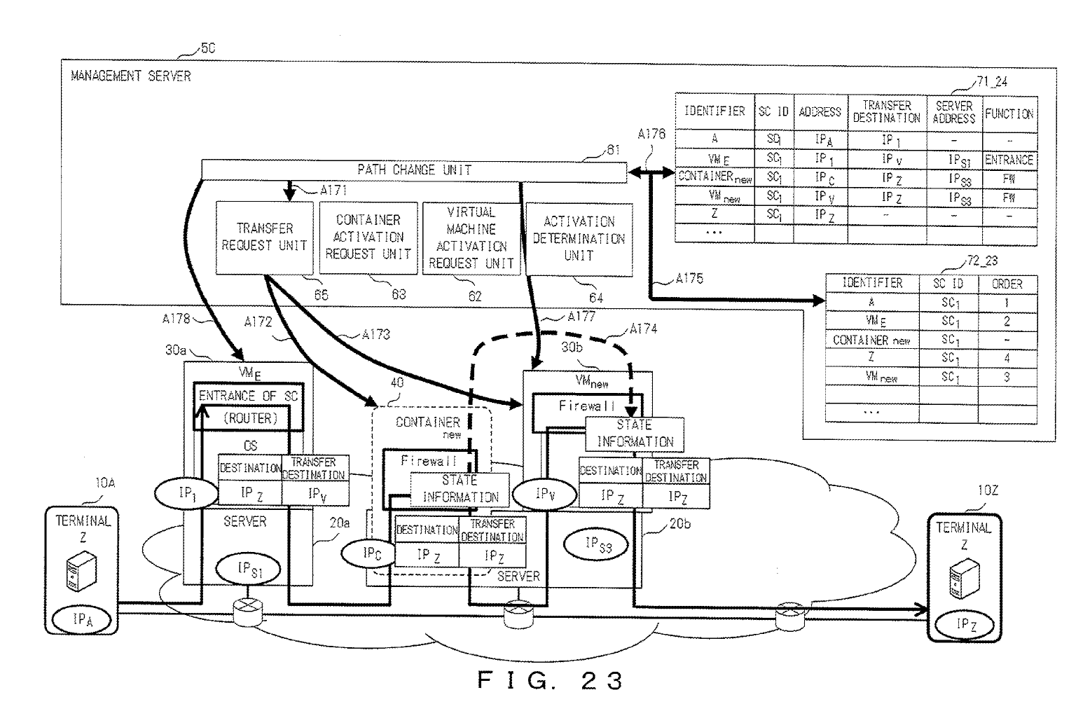

FIG. 23 is an explanatory diagram of an example of a process executed in the fourth embodiment when the virtual machine 30 has been activated. The process indicated by arrows A171 to A174 are similar to that indicated by the arrows A32 to A35 described with reference to FIG. 16. With the process indicated by the arrows A171 to A174, the virtual machine 30b takes over state information generated by the container 40.

After the virtual machine 30b has taken over the state information generated by the container 40, the path change unit 61 changes the SC management table 72 to an SC management table 72_23 (arrow A175). With this process, a path that extends from the terminal 10A to the terminal 10Z via the virtual machine 30a and the virtual machine 30b is decided as the path used for the transmission process from the terminal 10A to the terminal 10Z in the service chain SC₁ when the container 40 has been replaced with the virtual machine 30b. The path change unit 61 changes the element management table 71 to an element management table 71_24 in order to suit the path used in the service chain SC₁ (arrow A176).

Additionally, the path change unit 61 transmits a switching request message to the virtual machine 30a and the virtual machine 30b (arrows A177 and A178). The process indicated by the arrows A177 and A178 is similar to that indicated by the arrows A23 and A24 described with reference to FIG. 13. Accordingly, with the process indicated by the arrows A177 and A178, the transfer path in the service chain SC₁ is changed from the path illustrated in FIG. 22 to that illustrated in FIG. 23.

As described above, the method according to this embodiment is applicable not only to the case where a virtual machine 30 is added to an existing service chain but also to the case where a new service chain is generated. Accordingly, a service chain is established by using a container 40 until the virtual machine 30 is activated, so that the timing at which the service chain starts to be used can be made earlier than in the case where the container 40 is not used.

### Modification Example

The first to the fourth embodiments have been described by taking, as an example, the case where one virtual machine 30 is added to the service chain. However, a plurality of virtual machines 30 may be added to one service chain at a time. When a plurality of virtual machines 30 are added to one service chain at a time, a container 40 that executes, as a substitute, the process of a virtual machine 30 is associated with each newly activated virtual machine 30 in the element management table 71 so that the container 40 can be definitely identified.

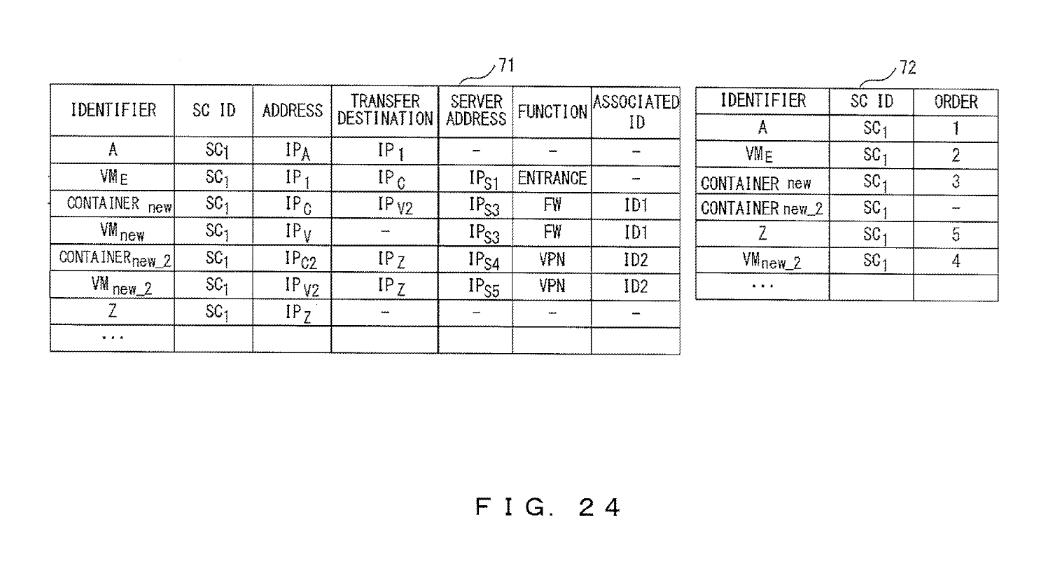

FIG. 24 illustrates examples of tables used to add a plurality of virtual machines 30. When the plurality of virtual machines 30 are activated, the element management table 71 includes an associated ID in addition to an identifier of a device, a SC ID, an address of the device, a transfer destination of a packet, an address assigned to a server in which the device is operating, and a function of the device. The associated ID is decided by the path change unit 61 for each virtual machine to be activated. Here, associated IDs are decided so that the associated IDs do not become the same value in the plurality of virtual machines within one service chain. When the path change unit 61 makes a request to activate a virtual machine 30, the path change unit 61 notifies the virtual machine activation request unit 62 of an associated ID decided for the virtual machine 30 for which the activation request is made. Also when the path change unit 61 makes, to the container activation request unit 63, a request to activate a container 40, the path change unit 61 notifies the container activation request unit 63 of the associated ID decided for the virtual machine 30 for which the container 40 executes, as a substitute, the process of the virtual machine 30.

For example, FIG. 24 illustrates the element management table 71 in a case where two virtual machines such as VM_{new} and VM_{new}_{_}₂ are activated in the service chain. In this example, the path change unit 61 decides an ID associated with the virtual machine 30 identified with VM_{new} and an ID associated with the virtual machine 30 identified with VM_{new}_{_}₂ to be ID1 and ID2, respectively. The path change unit 61 notifies the virtual machine activation request unit 62 of the associated ID=ID1 when the path change unit 61 makes, to the virtual machine activation request unit 62, a request to activate the virtual machine 30 (VM_{new}) that operates as a firewall. Meanwhile, the path change unit 61 also notifies the container activation request unit 63 of the associated ID=ID1 when the path change unit 61 makes, to the container activation request unit 63, a request to activate the container 40 (container_{new}) that operates as a firewall. Accordingly, the virtual machine activation request unit 62 sets the associated ID to ID1 when information about the virtual machine 30 identified with VM_{new} is recorded in the element management table 71. Similarly, the container activation request unit 63 also sets the associated ID to ID1 when it records, in the element management table 71, information of the container 40 (container_{new}) that operates as a firewall. A similar process is also executed for the virtual machine 30 identified with VM_{new}_{_}₂ and the container 40 (the associated ID=ID2) identified with container_{new}_{_}₂. Here, the virtual machine 30 identified with VM_{new}_{_}₂ and the container 40 provide the function of a VPN (Virtual Private Network).

When the virtual machine 30 (associated ID=ID1) identified with VM_{new} has been activated, the path change unit 61 identifies the container 40 having the associated ID=ID1 by referencing the element management table 71. The path change unit 61 switches the transfer path used for the process in the service chain to that passing through the virtual machine 30 having the associated ID=ID1.

Meanwhile, assume that the virtual machine 30 (associated ID=ID2) identified with VM_{new}_{_}₂ has been activated. In this case, the path change unit 61 replaces the transfer path of the service chain with the transfer path using the virtual machine 30 identified with VM_{new}_{_}₂ as a substitute for the container 40 having the associated ID=ID2.

Since there is no association between the value of an associated ID and the order of activation, activation starts from a virtual machine 30 having an arbitrary associated ID. For example, in the SC management table 72 illustrated in FIG. 24, the virtual machine 30 having the associated ID=ID2 is activated earlier than the virtual machine 30 having the associated ID=ID1. Accordingly, the path that extends from the terminal 10A to the terminal 10Z passes through the virtual machine 30 identified with VM_{E}, the container 40 identified with container_{new}, and the virtual machine 30 identified with VM_{new}_{_}₂.

As described above, association information that associates a virtual machine 30 to be added with a container 40 that executes, as a substitute, the process of the virtual machine 30 is recorded in the element management table 71, whereby the process for adding a plurality of virtual machines 30 can be easily executed.

### Fifth Embodiment

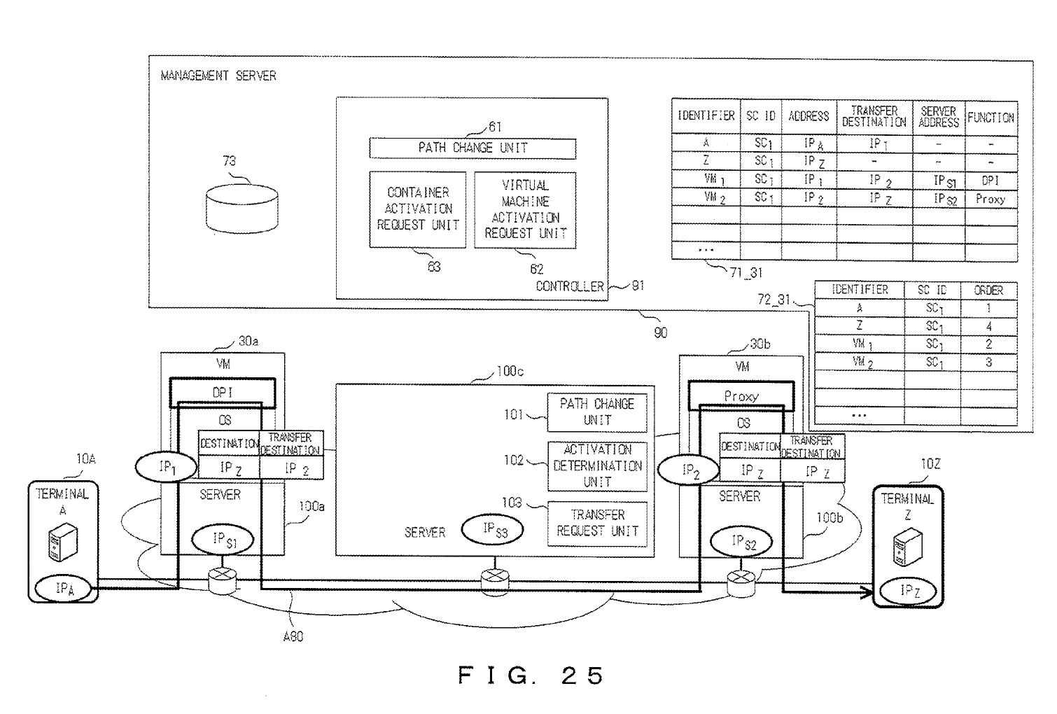

FIG. 25 is an explanatory diagram of an example of a network to which a fifth embodiment is applied. The fifth embodiment refers to a case where a server 100 executes a path switching process. Therefore, a management server 90 used in the fifth embodiment does not include the activation determination unit 64 and the transfer request unit 65. Meanwhile, the server 100 within a network includes a path change unit 101, an activation determination unit 102 and a transfer request unit 103. An example of a process executed in the fifth embodiment is described below by taking, as an example, a case where the virtual machine 30c that operates as a firewall is added when a service chain using the path indicated by an arrow A80 is set. Assume that the management server 90 holds an element management table 71_31 and an SC management table 72_31 when the path indicated by the arrow A80 is set. Accordingly, a packet addressed from the terminal 10A to the terminal 10Z reaches the terminal 10Z via the virtual machine 30a and the virtual machine 30b. Moreover, the virtual machine 30a operates as a DPI, and the virtual machine 30b operates as a proxy.

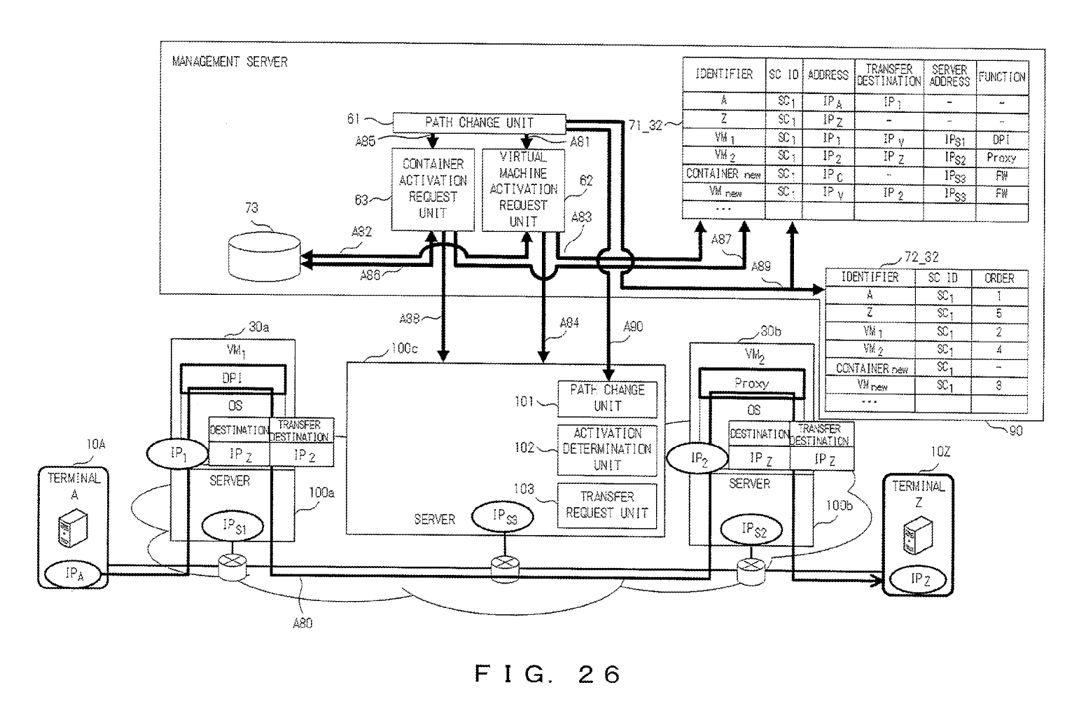

FIG. 26 is an explanatory diagram of an example of the process executed in the fifth embodiment. Upon detecting that a request to add the virtual machine 30c has been made, the path change unit 61 makes, to the virtual machine activation request unit 62, a request for a process for activating the virtual machine 30c (arrow A81). The process executed by the virtual machine activation request unit 62 (arrows A82 to A84) is similar to that indicated by the arrows A3 to A5 described with reference to FIG. 8. Moreover, the path change unit 61 makes, to the container activation request unit 63, a request for a process for activating a container 40 that executes, as a substitute, the process of the virtual machine 30c until the virtual machine 30c is activated (arrow A85). The process executed by the virtual machine activation request unit 62 (arrows A86 to A88) is similar to that indicated by the arrows A6 to A8 described with reference to FIG. 8. The example of FIG. 26 assumes that both the container 40 and the virtual machine 30c are activated in the server 100c.

In an arrow A89, by referencing the element management table 71 and the SC management table 72, the path change unit 61 calculates a transfer path used in a service chain when the container 40 is activated. In the example illustrated in FIG. 26, the transfer path of the service chain when the container 40 is activated is a path that extends from the terminal 10A to the terminal 10Z via the virtual machine 30a (VM₁), the container 40 and the virtual machine 30b (VM₂). Moreover, the path change unit 61 calculates a transfer path used in the service chain when the virtual machine 30c is activated. The transfer path of the service chain when the virtual machine 30c is activated is a path that extends from the terminal 10A to the terminal 10Z via the virtual machine 30a (VM₁), the virtual machine 30c (VM_{new}) and the virtual machine 30b (VM₂). The path change unit 61 records information of the path when the virtual machine 30c is activated in the element management table 71 and the SC management table 72. Accordingly, when the process indicated by the arrow A89 is terminated, the management server 90 holds an SC management table 72_32 and an element management table 71-32.

In an arrow A90, the path change unit 61 report the transfer path used when the container 40 is activated and the transfer path used when the virtual machine 30c is activated to the path change unit 101 of the server 100c. At this time, the path change unit 61 also notifies the path change unit 101 of information of a device for which a transfer destination is changed when each of the paths is used. For example, in the case illustrated in FIG. 26, the path change unit 61 notifies the path change unit 101 of the server 100 in which the container 40 is to be activated of the following information.

Activation process of the container 40
a condition for determining whether the container 40 has been activated
a path used when the container 40 has been activated: IP_{A}→IP₁→IP_{C}→IP₂→IP_{Z}
a device for which a transfer destination is set, and a setting: IP₁ (a transfer destination of a packet addressed to IP_{Z}: IP_{C})
a device for which a transfer destination is set, and a setting: IP_{C} (a transfer destination of a packet addressed to IP_{Z}: IP₂)

Activation process of the virtual machine 30c
a condition for determining whether the virtual machine 30c has been activated
an address of a server 100 in which the virtual machine 30c is activated
whether state information is taken over from the container 40: YES
a path used when the virtual machine 30c is activated: IP_{A}→IP₁→IP_{V}→IP₂→IP_{Z}
a device for which a transfer destination is set, and a setting: IP₁ (a transfer destination of a packet addressed to IP_{Z}: IP_{V})
a device for which a transfer destination is set, and a setting: IP_{V} (a transfer destination of a packet addressed to IP_{Z}: IP₂)

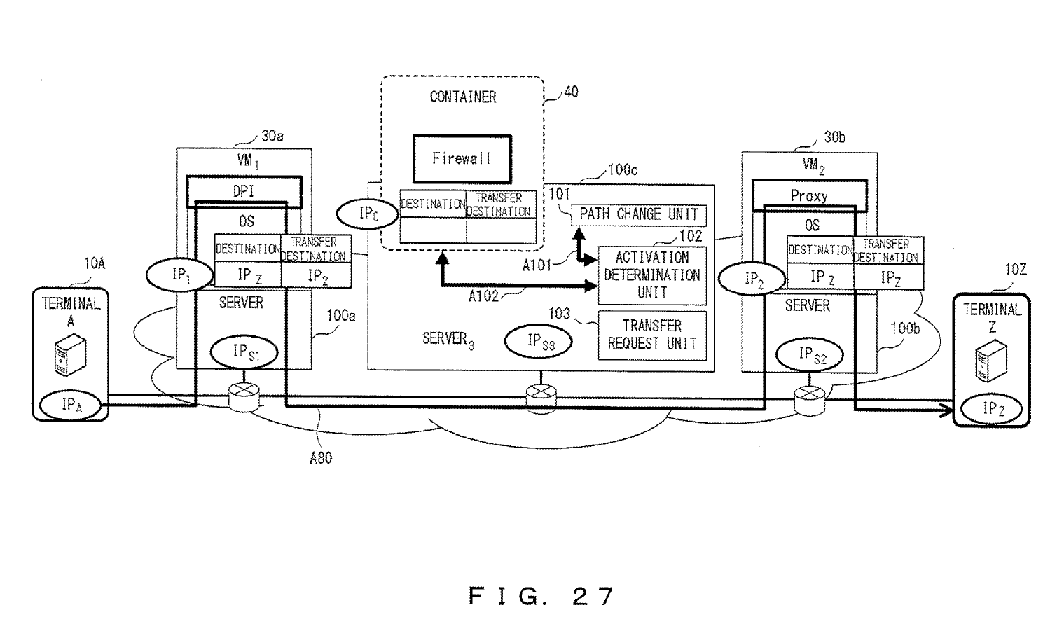

FIG. 27 is an explanatory diagram of an example of the process executed in the fifth embodiment when it is determined whether the container 40 has been activated.

In an arrow A101, the path change unit 101 notifies the activation determination unit 102 of the activation determination condition of the container 40 and the activation determination condition of the virtual machine 30c among information obtained from the path change unit 61.

In an arrow A102, the activation determination unit 102 determines whether the container 40 has been activated by using the activation determination condition of the container 40 among the conditions notified from the path change unit 101. The activation determination unit 102 periodically determines whether the activation of the container 40 has been completed until it can verify that the container 40 is activated. When the container 40 has been activated, the activation determination unit 102 notifies the path change unit 101 that the activation of the container 40 has been completed.

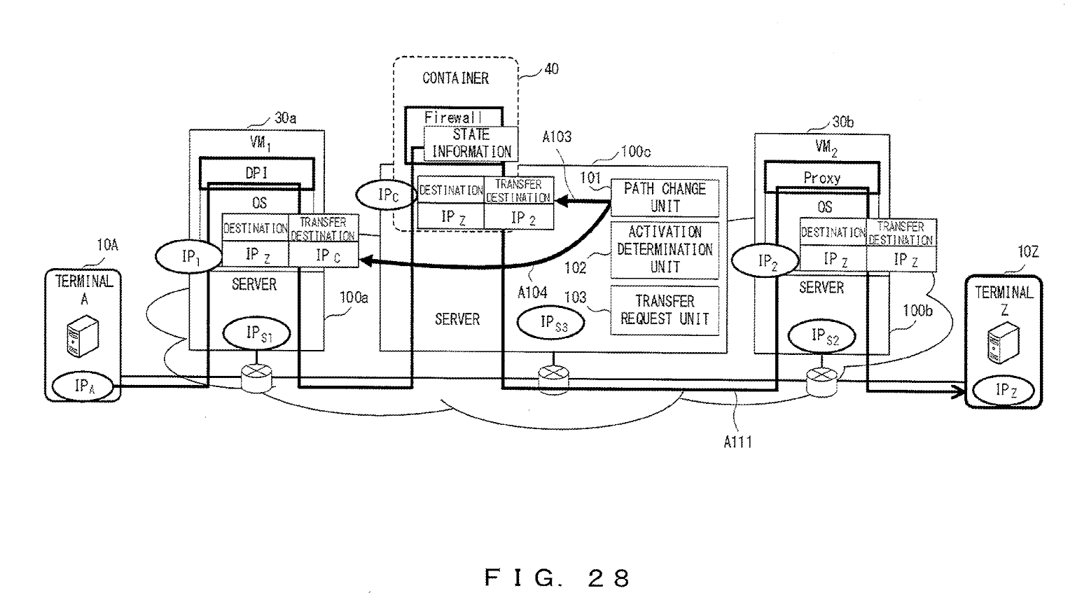

FIG. 28 is an explanatory diagram of an example of the process executed in the fifth embodiment when the container 40 has been activated. The path change unit 101 sets the transfer destination of the packet addressed to the terminal 10Z (IP_{Z}) in the virtual machine 30a (address=IP₁) and the container 40 (address=IP_{C}) by using the information notified from the path change unit 61 (arrows A103, A104). In the arrow A104, the path change unit 101 transmits a switching message to the virtual machine 30a. With this process, the transfer path of the service chain is switched from the arrow A80 (FIG. 27) to an arrow A111.

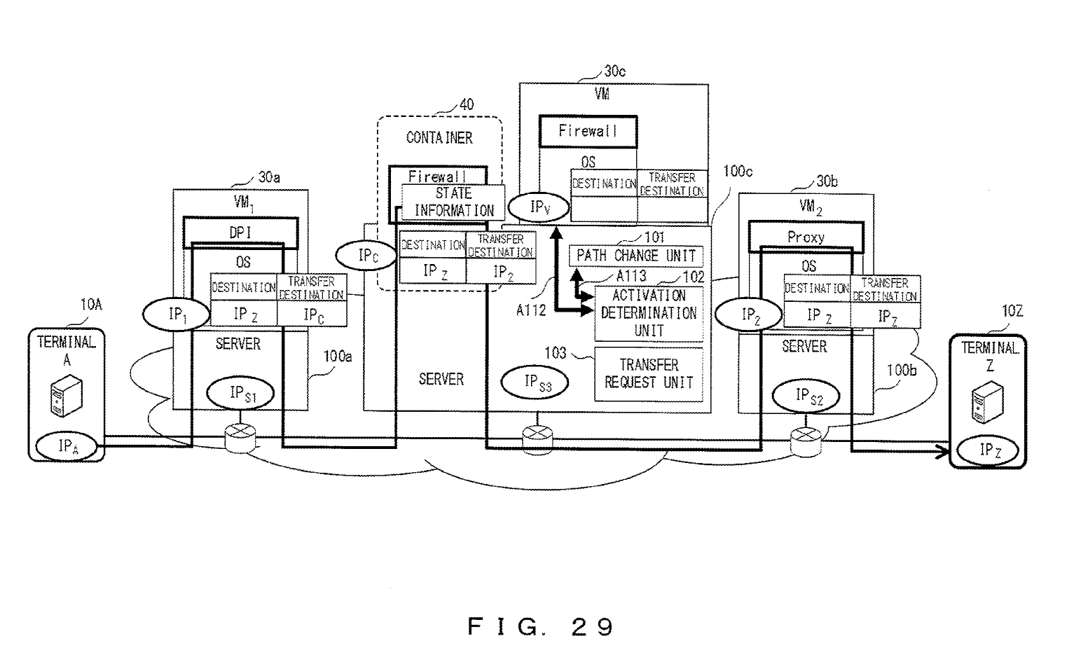

FIG. 29 is an explanatory diagram of an example of the process executed in the fifth embodiment when it is determined whether the activation of the virtual machine 30c has been completed.

In an arrow A112, the activation determination unit 102 determines whether the virtual machine 30c has been activated by using the activation determination condition of the virtual machine 30c among the conditions notified from the path change unit 101. The activation determination unit 102 periodically determines whether the activation of the virtual machine 30c has been completed until it can verify that the virtual machine 30c is activated. The activation determination unit 102 notifies the path change unit 101 that the activation of the virtual machine 30 has been completed when the virtual machine 30c was activated (arrow A113).

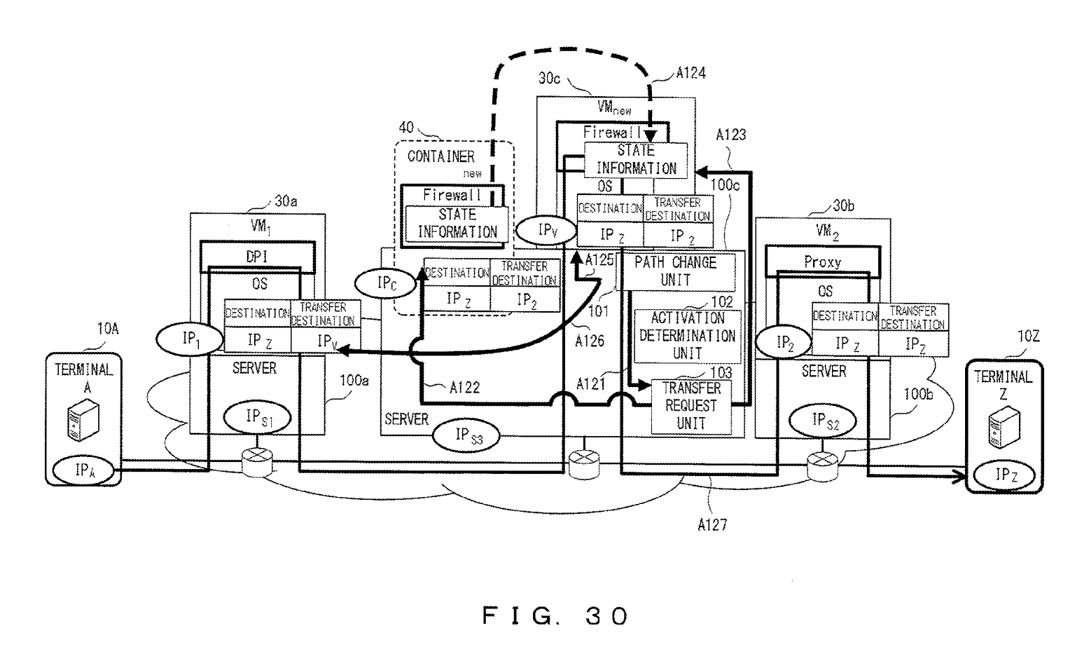

FIG. 30 is an explanatory diagram of an example of the process executed in the fifth embodiment when the virtual machine 30c has been activated. When the path change unit 101 is notified that the virtual machine 30c has been activated, it is determined whether state information is taken over from the container 40 for the virtual machine 30c. As described above with reference to FIG. 26, the path change unit 101 is notified of information “whether state information has been taken over from the container 40=YES” for the virtual machine 30c. Accordingly, the path change unit 101 determines that the state information is taken over from the container 40 to the virtual machine 30c, and notifies the transfer request unit 103 that the virtual machine 30c has been activated (arrow A121).

The transfer request unit 103 makes, to the container 40, a request to transmit the state information generated at the time of the transfer process of a packet to the virtual machine 30c (arrow A122). Moreover, the transfer request unit 103 makes, to the virtual machine 30c, a request to receive the state information from the container 40 and to use the received state information for the process of the packet (arrow A123). The container 40 transmits the state information to the virtual machine 30c in response to the request made from the transfer request unit 103 (arrow Al24). Meanwhile, the virtual machine 30c uses the state information received from the container 40 for the subsequent process. Namely, with the process indicated by the arrow Al24 and subsequent ones, the state information generated by the container 40 is taken over by the virtual machine 30c. Therefore, the function of the firewall can be continuously provided even if the container 40 within the service chain SC₁ is replaced with the virtual machine 30c.

Next, the path change unit 101 sets the transfer destination of the packet addressed to the terminal 10Z (IP_{Z}) in the virtual machine 30a (address=IP₁) and the virtual machine 30c (address=IP_{V}) by using the information notified from the path change unit 61 (arrows Al25, Al26). Accordingly, the transfer path of the service chain is switched from the arrow A111 (FIG. 28) to an arrow Al27.

The process executed in the fifth embodiment has been described with reference to FIGS. 25 to 30 by taking, as an example, the case where the container 40 and the virtual machine 30 are activated in the same server 100. However, the container 40 and the virtual machine 30 may be activated respectively in different servers 100. Also when the container 40 and the virtual machine 30 are activated in different servers 100, the management server 90 notifies the path change unit 101 within the server 100 in which the container 40 is activated of the address of the server 100 in which the virtual machine 30 is activated. Accordingly, the path change unit 101 within the server 100 in which the container 40 is activated accesses the server 100 in which the virtual machine 30 is activated, so that it can be determined whether the activation of the virtual machine 30 has been completed.

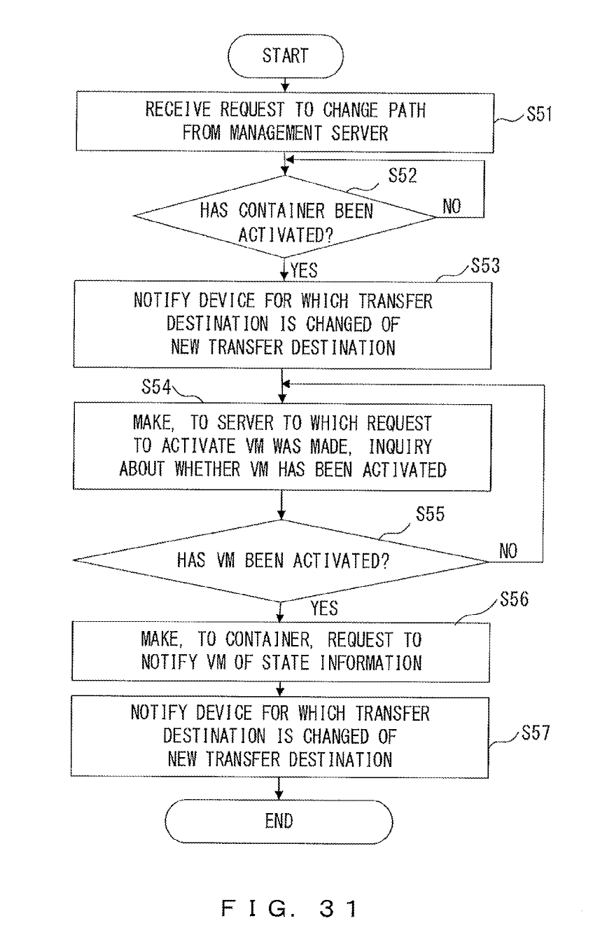

FIG. 31 is a flowchart for explaining an example of the process executed in the fifth embodiment. FIG. 31 illustrates an example of the process executed by the server 100 in which the container 40 is activated. FIG. 31 illustrates an example of the case where the container 40 and the virtual machine 30 are activated in different servers 100.

The path change unit 101 receives a request to change a path from the management server 90 (step S51). The activation determination unit 102 determines whether the container 40 has been activated, and waits (“NO” in step S52) until the container 40 is activated. When the container 40 has been activated, the path change unit 101 notifies a device for which a transfer destination of a packet is changed due to the activation of the container 40 of a new transfer destination (“YES” in step S52, step S53). The activation determination unit 102 makes, to the server 100 to which the request to activate the virtual machine 30 is made, an inquiry about whether the activation of the virtual machine 30 has been completed (step S54). The activation determination unit 102 determines whether the activation of the virtual machine 30 has been completed, and waits (“NO” in step S55) until the activation of the virtual machine 30 is completed. When the activation of the virtual machine 30 has been completed, the path change unit 101 makes, to the container 40, a request to notify the virtual machine 30 of state information (“YES” in step S55, step S56). Moreover, the path change unit 101 notifies the device for which the transfer destination of the packet is changed of a new transfer destination due to the activation of the virtual machine 30 (step S57).

As described above in the fifth embodiment, the server 100 executes the path switching process, so that the processing load imposed on the management server 90 is lightened in comparison with the first to the fourth embodiments.

### Other Embodiments

Note that the embodiments are not limited to those described above, and can be diversely modified. Some examples of modified embodiments are described below.

The above description has been provided by taking, as an example, the case where it is verified that the container 40 or the virtual machine 30 has been activated by having the activation determination unit 64 make an inquiry. However, the method for determining whether the container 40 or the virtual machine 30 has been activated may be changed.

For example, the server 20 to which a request to activate a container 40 has been made may determine whether the activation of the container 40 has been completed. At this time, the server 20 determines whether a process is being executed by the container 40, and determines that the container 40 has been activated if the process is being executed. Moreover, the server 20 notifies the management server 50 that the container 40 has been activated by transmitting an activation completion message to the management server 50 when it verifies that the activation of the container 40 has been completed. The activation completion message includes information for uniquely identifying the activated container 40. Upon receipt of the activation completion message from the server 20, the activation determination unit 64 determines that the container has been activated, which has been notified with the activation completion message, and notifies the path change unit 61 that the container 40 has been activated. Also, when a virtual machine 30 is activated, the server 20 in which the virtual machine 30 is activated similarly transmits an activation completion message to the management server 50 when it verifies that the virtual machine 30 has been activated.

By modifying the embodiment in this way, the number of messages transmitted from the management server 50 to the server 20 is reduced. Accordingly, the load of the process that is executed by the management server 50 in order to verify that the container 40 or the virtual machine 30 has been activated is lightened even if the number of service chains managed by the management server 50 increases.

Additionally, the embodiments may be modified so that the activation determination unit 64 can make an inquiry about whether the container 40 or the virtual machine 30 has been activated, which has been notified with an activation completion message when the management server 50 has received the activation completion message. Also in this case, the activation determination unit 64 does not execute the inquiry process until the completion of the activation of the container 40 or the virtual machine 30 is notified. Therefore, the processing load imposed on the management server 50 is lightened. Moreover, the activation determination unit 64 verifies that the virtual machine 30 or the container 40 has been activated at the timing when the activation completion message is received, whereby a malfunction is less prone to occur.

Furthermore, a predicted value of the length of time used from an activation request until the completion of activation may be preset for each of the container 40 and the virtual machine 30. When the length of time elapsed from a time at which the request to activate the container 40 has been made from the container activation request unit 63 reaches the predicted value needed to activate the container 40, the activation determination unit 64 determines that the container 40 has been activated, and notifies the path change unit 61 that the container 40 has been activated. Also for the virtual machine 30, when the length of time elapsed from a time at which the request to activate the virtual machine 30 has been made from the virtual machine activation request unit 62 reaches a predicted value of the length of time used to activate the virtual machine 30, the activation determination unit 64 determines that the virtual machine 30 has been activated, and notifies the path change unit 61 that the virtual machine 30 has been activated. By modifying the embodiments in this way, the management server 50 does not transmit a message in order to determine whether the container 40 or the virtual machine 30 has been activated, whereby the processing load is lightened.

The information elements included in the above described tables may be changed in accordance with an implementation. Also, the information elements included in the control messages such as an activation request message and the like may be changed. For example, the activation request message may include the identifier of the container 40 or the virtual machine 30 to be activated as a replacement for a service chain identifier (SC ID). Moreover, for example, an activation request message including, as data, the following information elements may be transmitted to the server 20c as a replacement for P13 illustrated in FIG. 9:

a request to activate a virtual machine 30

an identifier of a virtual machine 30 to be activated: VM_{new}

an IP address of the virtual machine 30 to be activated: IP_{V}

a type of the virtual machine 30 to be activated: FW

To the activation request messages illustrated in FIG. 9, an identifier of a container 40 or a virtual machine 30 to be activated may be also added.

Additionally, the rewrite request message may be modified so that it can be transmitted to a server 20 in which a virtual machine 30 or a container 40 is operated. In this case, the rewrite request message includes information indicating a setting destination of a change in a transfer destination notified with the rewrite request message in addition to the information elements illustrated in FIG. 11.

The process referred to in the second embodiment is merely one example of the method with which a container 40 that executes, as a substitute, the process of a virtual machine 30 transmits generated state information. The method with which the virtual machine 30 obtains the state information generated by the container 40 can be changed in accordance with an implementation. For example, the management server 50 makes, to the container 40, a request to transfer state information to the virtual machine 30. However, for a virtual machine 30, the management server 50 does not particularly make a request to receive state information from the container 40. Also, in this case, the virtual machine 30 uses information received from the container 40 as state information.

Additionally, the management server 50 may relay state information. In this case, when the virtual machine 30 has been activated, the path change unit 61 makes, to the transfer request unit 65, a request to cause an activated virtual machine 30 (VM_{new}) to take over the state information generated by the container 40. The transfer request unit 65 request the container 40 to transfer the state information used for the transfer process executed in the container 40 to the management server 50. At this time, the transfer request unit 65 transmits, to the container 40, a request message including an address assigned to the management server 50, information for identifying the type of the state information transmitted to the management server 50, and the like. Upon receipt of the request from the management server 50, the container 40 transmits the state information to the management server 50. The state information is managed by the transfer request unit 65 of the management server 50.

Next, the transfer request unit 65 transmits a request including an instruction for making a request to use the state information for the transfer process of a packet, and the state information, to the virtual machine 30 (VM_{new}) that takes over the process executed by the container 40. The virtual machine 30 identified with VM_{new} stores received data as the state information upon receipt of the request from the management server 50.

In all of the embodiments, when a path including a container 40 has been switched to a path including a virtual machine 30 for which the container 40 executes, as a substitute, a process of the virtual machine 30, the container 40 is deleted. When the path change unit 61 switches the path, the path change unit 61 makes a request to delete the container 40 to the server 20 in which the container 40 is operated. Meanwhile, when the path change unit 101 within the server 100 switches the path, the path change unit 101 makes a request to terminate the container 40. Note that the request to delete the container 40 may be made to the container 40 itself. When the request to delete the container 40 is made to the server 20, at least one of the identifier of the container 40, a service chain ID, an associated ID and the like is used when the container 40 to be deleted is identified.

In all of the above described embodiments, the length of time needed until a requested communication function starts in a service chain can be reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A management server that manages a transfer path within a network, the management server comprising:
a transmitter configured to transmit a request to activate a virtual machine included in the transfer path, and a request to activate an application that executes, as a substitute for the virtual machine, a transfer process executed by the virtual machine until the virtual machine is activated; and
a processor configured to set a first path including an execution device that executes the application in the transfer path after the application has been activated, and to switch the first path to a second path in which the execution device in the first path is replaced with the virtual machine after the virtual machine has been activated.

2. The management server according to claim 1, wherein
the processor
makes a request for the execution device to transmit, to the virtual machine, information generated when the execution device executes, as a substitute, the process executed by the virtual machine,
makes a request for the virtual machine to receive the information from the execution device, and
switches the first path to the second path when the virtual machine has received the information.

3. The management server according to claim 1, wherein
when the device that executes the process in the transfer path is replaced with the virtual machine, the processor
makes a request for a target device that is to be replaced with the virtual machine to transfer, to the execution device, first communication information that the target device uses for the transfer process,
makes a request for the execution device to obtain the first communication information from the target device,
makes a request for the execution device to transmit, to the virtual machine, second communication information that the execution device generates by executing a process using the first communication information when the virtual machine has been activated, and
switches the first path to the second path when the virtual machine has received the second communication information.

4. The management server according to claim 1, wherein:
the transmitter transmits a request to respectively activate a plurality of virtual machines, and a request to activate a plurality of applications that execute, as a substitute for the virtual machines, processes respectively executed by the plurality of virtual machines when the plurality of virtual machines are included in the transfer path;
the processor sets a path including a device that executes any of the plurality of applications; and
a device in which an application that executes, as a substitute, a process of a virtual machine the activation of which can be verified among the plurality of virtual machines is replaced with the virtual machine the activation of which can be verified, in the transfer path.

5. A communication system, comprising:
a management server configured to manage a transfer path within a network; and
a communication server configured to execute a communication process within the network, wherein
the management server transmits, along with information of the transfer path,
a request to activate a virtual machine included in the transfer path, and
a request to activate an application that executes, as a substitute for the virtual machine, a transfer process executed by the virtual machine until the virtual machine is activated, and
the communication server sets a first path including the communication server in the transfer path after the application has been activated, and
the first path is switched to a second path in which the communication server within the first path is replaced with the virtual machine after the virtual machine has been activated.

6. The communication system according to claim 5, further comprising
a different server that operates within the network, wherein
the management server
transmits, to the communication server, a request to activate the application, and information of the transfer path, and
transmits, to the different communication server,
a request to activate a virtual machine included in the transfer path, and
the communication server switches the first path to the second path when the communication server verifies that the virtual machine has been activated in the different communication server.

7. A path management method, comprising:
transmitting a request to activate a virtual machine included in a transfer path, and a request to activate an application that executes, as a substitute for the virtual machine, a transfer process executed by the virtual machine until the virtual machine is activated, the transmitting being performed by a management server that manages the transfer path within a network;
setting a first path including an execution device that executes the application after the application has been activated, the setting being performed by the management server; and
switching the first path to a second path in which the execution device in the first path is replaced with the virtual machine after the virtual machine has been activated, the switching being performed by the management server.

8. The path management method according to claim 7, further comprising:
making a request for the execution device to transmit, to the virtual machine, information generated when the execution device executes, as a substitute for the virtual machine, the process executed by the virtual machine, the making of the request being performed by the management server;
making a request for the virtual machine to receive the information from the execution device, the making of the request being performed by the management server; and
switching the first path to a second path when the virtual machine has received the information, by the management server.

9. The path management method according to claim 7, comprising:
when a target device that executes the process in the transfer path is replaced with the virtual machine,
making, by the management server, a request for the target device to transfer, to the execution device, first communication information that the target device uses for the transfer process, and
making, by the management server, a request for the execution device to obtain the first communication information from the target device;
when the virtual machine has been activated,
making, by the management server, a request for the execution device to transmit second communication information that the execution device generates by executing a process using the first communication information; and
when the virtual machine has received the second communication information, switching the first path to the second path, by the management server.

10. The path management method according to claim 7, further comprising:
transmitting, by the management server,
a request to respectively activate a plurality of virtual machines, and
a request to activate a plurality of applications that execute, as a substitute for the virtual machines, processes respectively executed by the plurality of virtual machines when the plurality of virtual machines are included in the transfer path;
setting, in the transfer path, a path including a device that executes any of the plurality of applications, by the management server; and
replacing, in the transfer path, a device in which an application that executes, as a substitute, a process of a virtual machine the activation of which can be verified, the replacing being performed by the management server.
